(19) United States
(12) Patent Application Publication
(10) Pub. No.: US 2010/0188048 A1
(43) Pub. Date: Jul. 29, 2010

(54) NONAQUEOUS SECONDARY BATTERY, BATTERY PACK, POWER SUPPLY SYSTEM, AND ELECTRICAL DEVICE

(76) Inventors: Hajime Nishino, Nara (JP); Kohei Suzuki, Osaka (JP); Shigeo Ikuta, Kagoshima (JP); Akiko Fujino, Osaka (JP)

Correspondence Address: MCDERMOTT WILL & EMERY LLP, 600 13TH STREET, NW, WASHINGTON, DC, 20005-3096, US

(21) Appl. No.: 12/666,137

(22) PCT Filed: May 21, 2008
(86) PCT No.: PCT/JP2008/001263

§ 371 Date: Dec. 22, 2009

(30) Foreign Application Priority Data
Jun. 22, 2007 (JP) 2007-165460
May 7, 2008 (JP) 2008-121638

(51) Int. Cl. H02J 7/04; H01M 4/58; H01M 6/42

(52) U.S. Cl. 320/120; 429/231.95; 429/156

(57) ABSTRACT

A nonaqueous secondary battery includes a negative electrode plate 303 containing a negative electrode active material 324 capable of reversely inserting and extracting lithium, a positive electrode plate 301 containing lithium as a positive electrode active material 322, an electrolyte, a porous protective membrane 325 provided between the negative electrode plate 303 and the positive electrode plate 301 and permeable to lithium ions while having heat resistance, and a concave portion 352 in which growth of deposited metal, which is formed according to a set voltage Vs, is controlled in such a manner that the deposited metal is bridged between the negative electrode plate 303 and the positive electrode plate 301 when the set voltage Vs is applied between the negative electrode plate 303 and the positive electrode plate 301.

### TECHNICAL FIELD

The present invention relates to a nonaqueous secondary battery, a battery pack using the same, a power supply system charging the nonaqueous secondary battery, and an electrical device using the nonaqueous secondary battery.

### BACKGROUND ART

Recently, a demand for a power supply system using a secondary battery and an electrical device incorporating the power supply system has been increasing because of inconvenience and with an intention to reduce the burden on the environment. A secondary battery serving as a power supply includes a lead storage battery and an alkaline storage battery and a nonaqueous electrolyte secondary battery (nonaqueous secondary battery) having high energy density per volume (and per weight) attracts the most attention.

A nonaqueous electrolyte secondary battery chiefly uses a lithium transition metal complex oxide as an active material of the positive electrode and chiefly uses a material capable of inserting and extracting lithium, such as graphite and silicon compound, as an active material of the negative electrode. An electrode group is formed by interposing a separator between the positive electrode and the negative electrode, and the nonaqueous electrolyte secondary battery is formed by accommodating the electrode group together with a nonaqueous electrolyte in a case.

A lithium transition metal complex oxide used as an active material of the positive electrode has high energy density whereas it lacks thermal stability at the time of overcharge. For this reason, besides the nonaqueous electrolyte secondary battery, the power supply system is provided with a control portion that controls a charge and a discharge of the nonaqueous electrolyte secondary battery between the upper limit voltage V_{U} and the lower limit voltage V_{L} in order to prevent an overcharge of the nonaqueous electrolyte secondary battery. For example, in a case where an active material of the positive electrode is lithium cobaltate and an active material of the negative electrode is a carbonaceous material, then the upper limit voltage V_{U} and the lower limit voltage V_{L} of the control portion are set to 3.8 to 4.2 V per cell and 2.5 to 3.5 V per cell, respectively.

Also, as a safeguard in the event of an abnormality, such as a case where the control portion breaks and a charge does not end even when the voltage reaches the upper limit voltage V_{U}, there is proposed a technique of forcedly stopping the flow of a current by providing the nonaqueous electrolyte secondary battery with a positive temperature coefficient (PCT) device exploiting a phenomenon that the active material and other constituent materials of the positive electrode generate heat at the time of overcharge (see, for example, Patent Document 1).

There is also proposed a technique by which a separator formed of a microporous film is provided with a point at which the tortuosity (the path length of a micropore with respect to a thickness of the separator) is 1 in order to lower the cell voltage by selectively letting lithium be deposited at this point in the case of overcharge, so that an overcharge of the nonaqueous electrolyte secondary battery is prevented substantially (see, for example, Patent Document 2).

FIG. 25 is a graph used to describe a typical management method of charging voltage and current when a secondary battery is charged. FIG. 25 is a graph in a case where an assembled battery formed of three secondary batteries, for example, lithium-ion batteries, connected in series, is charged. Reference numerals α11, α12, and α13 indicate changes of voltages across the respective secondary batteries and a reference numeral β11 indicates a change of a charging current supplied to the secondary batteries. Also, γ11 indicates a state of charge (SOC) of the assembled battery.

Initially, a constant current (CC) charge is started. The constant current (CC) charge is performed by supplying a charging current at a predetermined constant current value I1 until the terminal voltage between the charging terminals of a battery pack reaches a voltage found by multiplying 4.2 V per cell, which is a predetermined cut-off voltage of charge, Vf, by the number of series cells in the assembled battery (hence, for example, 12.6 V in the case of three series cells). As the current value I1, a current value found by multiplying, for example, 70% of 1 It by the number of parallel cells, P, is used. Herein, 1 It is a current value with which a residual capacity of a secondary battery becomes 0 when a nominal capacity value NC of the secondary battery is discharged for one hour at a constant current.

When the terminal voltage between the charging terminals reaches the cut-off voltage of charge, Vf,×the number of series cells, the region is switched to a constant voltage (CV) charge region. Then, the charging current value is decreased so as to maintain the cut-off voltage of charge, Vf,×the number of series cells. A full charge is determined when the charging current value has dropped to a current value I2 set by the temperature and a supply of the charging current is stopped. The charge control method as described above can be read, for example, from Patent Document 3.

Incidentally, the PCT device described in Patent Document 1 can change an operating temperature (a temperature at which the flow of a current is stopped forcedly) by changing the configuration. However, when the operating temperature is too low in summer when the ambient temperature is high, a malfunction occurs. On the contrary, when the operating temperature is too high, an operation may be delayed and an inconvenience (overheat) accompanying with an overcharge may possibly occur. As has been described, the operating principle of the PCT device described in Patent Document 1 exploits a phenomenon that an active material and other constituent materials of the positive electrode generates heat at the time of overcharge in the first place and the temperature has already risen because of an overcharge by the time the PCT device starts to operate. Moreover, because there is a need to avoid a malfunction caused by a temperature rise within a normal range, the operating temperature of the PCT device is set to a relatively high temperature with consideration from a variance of the operating temperature of the PCT device. Hence, it cannot be said that the safety is fully ensured.

Also, the technique described in Patent Document 2 uses a microporous film made of resin as a separator. Resin, such as polypropylene, used as a raw material of the microporous film is advantageous in that it can be readily made into a film by means of stretching whereas it has a problem that it readily undergoes heat-induced deformation. Hence, in a case where considerable heat is generated by an excessive charging current, the point at which the tortuosity is 1, that is, the deposition point of lithium undergoes heat-induced deformation and a hole is made in the separator. A short circuit current flowing between the electrodes is therefore increased further and there is a risk of a damage caused by heat generation and melting of the separator occurring in a chain reaction.

When the secondary battery deteriorates, internal resistance increases. Accordingly, when a plurality of secondary batteries are connected in series and a charging voltage is applied to the series circuit, the terminal voltage of a secondary battery having larger internal resistance, that is, a deteriorated secondary battery, becomes larger than those of the other intact batteries. The charging voltage is therefore no longer distributed evenly to the respective secondary batteries. Hence, as has been described above, in a case where a charge is performed until the terminal voltage between the charging terminals of the battery pack, that is, the terminal voltage across the assembled battery in which a plurality of secondary batteries are connected in series, reaches the cut-off voltage of charge, Vf×the number of series cells (12.6 V in the case of three series cells), as is shown in FIG. 25, the terminal voltage all across a deteriorated secondary battery exceeds 4.2 V and the secondary battery is overcharged whereas the terminal voltages a12 and a13 across intact secondary batteries become voltages smaller than 4.2 V.

When such an unbalanced state (imbalance) among the secondary batteries forming the assembled battery occurs, there arises a problem that a voltage exceeding 4.2 V is applied to the deteriorated secondary battery and the deteriorated secondary battery is overcharged and deteriorated further. In this case, in a case where the secondary batteries connected in series are, for example, nickel-metal hydride batteries or nickel cadmium batteries, it is known to eliminate the unbalanced state as follows.

That is, when a voltage higher than a normal cut-off voltage of charge is applied to the assembled battery having become unbalanced to bring the assembled battery into an overcharge state, oxygen is generated from the positive electrode and migrates to the negative electrode, so that oxygen is reduced in the negative electrode (Neumann's method). Migration of oxygen as described above is equivalent to a discharge of a charged electrical charge. Hence, the terminal voltage across the nickel-metal hydride battery or the nickel cadmium battery no longer rises even when a charge is continued in an overcharge state. The terminal voltage therefore becomes a constant voltage. Hence, by performing a charge in such a manner that a voltage higher than a normal cut-off voltage of charge is applied to the assembled battery having become unbalanced so that oxygen generated from the positive electrode is reduced in the negative electrode within all the secondary batteries, the terminal voltages across all the secondary batteries become the same voltage and remain constant. The unbalanced state is thus eliminated.

In the case of a lithium-ion secondary battery, however, unlike the nickel-metal hydride battery and the nickel cadmium battery, the terminal voltage does not stop at a constant voltage when a charge is continued in an overcharge state and the terminal voltage keeps rising according to an input electrical charge. Accordingly, when an unbalanced state occurs in an assembled battery formed by connecting a plurality of lithium-ion secondary batteries in series, the terminal voltage across each secondary battery becomes a different voltage that keeps rising even when the assembled battery is brought into an overcharge state. It thus becomes impossible to eliminate an unbalanced state. Under these circumstances, there is an inconvenience that an overcharge occurs in a markedly deteriorated secondary battery when an assembled battery in an unbalanced state is charged by applying a voltage equal to the cut-off voltage of charge, Vf,×the number of series cells.

Patent Document 1: JP-A-05-074493

Patent Document 2: JP-A-2002-164032

Patent Document 3: JP-A-6-78471

### DISCLOSURE OF THE INVENTION

The invention was devised in view of the foregoing circumstances and has an object to provide a nonaqueous secondary battery capable of lowering the risk of becoming an overcharge state, a battery pack using the same, a power supply system charging the nonaqueous secondary battery, and an electrical device using the nonaqueous secondary battery.

A nonaqueous secondary battery according to one aspect of the invention includes: a negative electrode containing at least one of a material capable of reversely inserting and extracting lithium and metal lithium as a negative electrode active material; a positive electrode containing lithium as a positive electrode active material; an electrolyte; and a heat resistant member provided between the negative electrode and the positive electrode and permeable to lithium ions while having heat resistance. In a case where a set voltage preset to a voltage lower than a voltage at which the electrolyte starts to decompose is applied between the negative electrode and the positive electrode, deposited metal is bridged between the negative electrode and the positive electrode according to the set voltage.

With the nonaqueous secondary battery configured as above, when the preset set voltage is applied between the negative electrode and the positive electrode, deposited metal is formed to bridge between the negative electrode and the positive electrode and the negative electrode and the positive electrode are short-circuited. A voltage between the negative electrode and the positive electrode is therefore maintained so as not to exceed the set voltage. Accordingly, the nonaqueous secondary battery as above is charged and the terminal voltage starts to rise. When the voltage between the negative electrode and the positive electrode reaches the set voltage, the terminal voltage is maintained so as not to exceed the set voltage even when the charge is continued. It is therefore possible to lower the risk of becoming an overcharge state. Also, in a case where an assembled battery in which a plurality of nonaqueous secondary batteries as above are connected in series, by applying a voltage equal to or higher than the set voltage to the respective nonaqueous secondary batteries, the voltages between the negative electrodes and the positive electrodes in all the nonaqueous secondary batteries substantially coincide with one another at the set voltage. It is therefore easy to reduce an imbalance among the respective nonaqueous secondary batteries.

Also, a battery pack according to another aspect of the invention includes an assembled battery in which the nonaqueous secondary battery described above is provided in a plural form and the nonaqueous secondary batteries are connected in series.

According to the battery pack configured as above, by applying a voltage to the assembled battery in such a manner that an applied voltage per nonaqueous secondary battery is equal to or higher than the set voltage, deposited metal is formed to bridge between the negative electrode and the positive electrode in each nonaqueous secondary battery and the negative electrode and the positive electrode are short-circuited. A voltage between the negative electrode and the positive electrode is therefore maintained so as not to exceed the set voltage. Accordingly, the voltages between the negative electrodes and the positive electrodes in all the nonaqueous secondary batteries substantially coincide with one another at the set voltage. It is therefore easy to reduce an imbalance among the respective nonaqueous secondary batteries.

Also, a power supply system according to still another aspect of the invention includes: an assembled battery in which any one of the nonaqueous secondary batteries described above is provided in a plural form and the nonaqueous secondary batteries are connected in series; a charging voltage supply portion that charges the assembled battery by supplying a charging voltage; a voltage detection portion that detects terminal voltages across the respective nonaqueous secondary batteries; an imbalance detection portion that determines an occurrence of an imbalance in a charge state among the nonaqueous secondary batteries in a case where the terminal voltages across the nonaqueous secondary batteries detected by the voltage detection portion satisfy a preset specific determination condition; and an imbalance correction control portion that supplies the assembled battery with a voltage equal to the set voltage multiplied by the number of the nonaqueous secondary batteries using the charging voltage supply portion in a case where the occurrence of an imbalance is determined by the imbalance detection portion.

According to the power supply system configured as above, a charging voltage is supplied to the assembly battery by the charging voltage supply portion and the nonaqueous secondary batteries included in the assembled battery are charged. When the terminal voltages across the respective nonaqueous secondary batteries satisfy the predetermined specific determination condition, the occurrence of an imbalance in a charge state among the nonaqueous secondary batteries is determined by the imbalance detection portion. Then, a voltage equal to the set voltage multiplied by the number of the nonaqueous secondary batteries is supplied to the assembled battery by the imbalance correction control portion, that is, a voltage is applied to the assembled battery in such a manner that the applied voltage per nonaqueous secondary battery becomes the set voltage. Accordingly, deposited metal is formed to bridge between the negative electrode and the positive electrode in each nonaqueous secondary battery and the negative electrode and the positive electrode are short-circuited. The voltage between the negative electrode and the positive electrode is therefore maintained so as not to exceed the set voltage. The voltages between the negative electrodes and the positive electrodes in all the nonaqueous secondary batteries thus substantially coincide with one another at the set voltage. It is therefore easy to reduce an imbalance among the nonaqueous secondary batteries.

Also, an electrical device according to still another aspect of the invention includes the nonaqueous secondary battery described above, and a load circuit driven by power supplied from the nonaqueous secondary battery.

According to the electrical device configured as above, it is possible to lower the risk that the nonaqueous secondary battery that supplies power to the load circuit in the electrical device becomes an overcharge state.

### BRIEF DESCRIPTION OF THE DRAWINGS

FIG. 1 is a block diagram showing an example of the configuration of a charge system according to one embodiment of the invention.

FIG. 2 is a schematic cross section showing an example of the configuration of a secondary battery shown in FIG. 1.

FIG. 3 is a cross section showing an example of the configuration of an electrode plate group shown in FIG. 2 in detail.

FIG. 4 is a front view showing an example of a separator shown in FIG. 2.

FIG. 5 is a cross section showing an example of the configuration of the electrode plate group shown in FIG. 2 in detail.

FIG. 6 is a cross section showing an example of the configuration of the electrode plate group shown in FIG. 2 in detail.

FIG. 7 is a cross section showing an example of the configuration of the electrode plate group shown in FIG. 2 in detail.

FIG. 8 is a cross section showing an example of the configuration of the electrode plate group shown in FIG. 2 in detail.

FIG. 9 is a cross section showing an example of the configuration of the electrode plate group shown in FIG. 2 in detail.

FIG. 10 is a perspective view showing an example of a porous protective membrane and a negative electrode plate shown in FIG. 9.

FIG. 11 is a cross section showing an example of the configuration of the electrode plate group shown in FIG. 2 in detail.

FIG. 12 is a cross section showing an example of the configuration of the electrode plate group shown in FIG. 2 in detail.

FIG. 13 is a view used to describe an example of an operation of the charge system shown in FIG. 1.

FIG. 14 is a flowchart showing an example of the operation of the charge system shown in FIG. 1.

FIG. 15 is a view in a tabular form used to describe the configurations of a cell according to an example of the invention and a cell in the background art.

FIG. 16 is a graph showing cell voltages and cell temperatures measured when the cells shown in FIG. 15 are charged as an experiment result.

FIG. 17 is an electron micrograph of the cross section of a negative electrode and a porous heat resistant layer in the cell of the example.

FIG. 18 is an electron micrograph of the cross section of the negative electrode and the porous heat resistance layer in the cell of the example.

FIG. 19 is an electron micrograph of the cross section of the negative electrode and the porous heat resistance layer in the cell of the example.

FIG. 20 is an electron micrograph of the surface of the porous heat resistance layer in the cell of the example.

FIG. 21 is an electron micrograph of the surface of the porous heat resistance layer in the cell of the example.

FIG. 22 is an electron micrograph of the surface of the porous heat resistance layer in the cell of the example.

FIG. 23 is an electron micrograph of the cross section of the cell of the example after a test.

FIG. 24 is an electron micrograph of the cross section of a cell of a comparative example after the test.

FIG. 25 is a graph used to describe a typical management method of charging voltage and current when a secondary battery in the background art is charged.

### BEST MODE FOR CARRYING OUT THE INVENTION

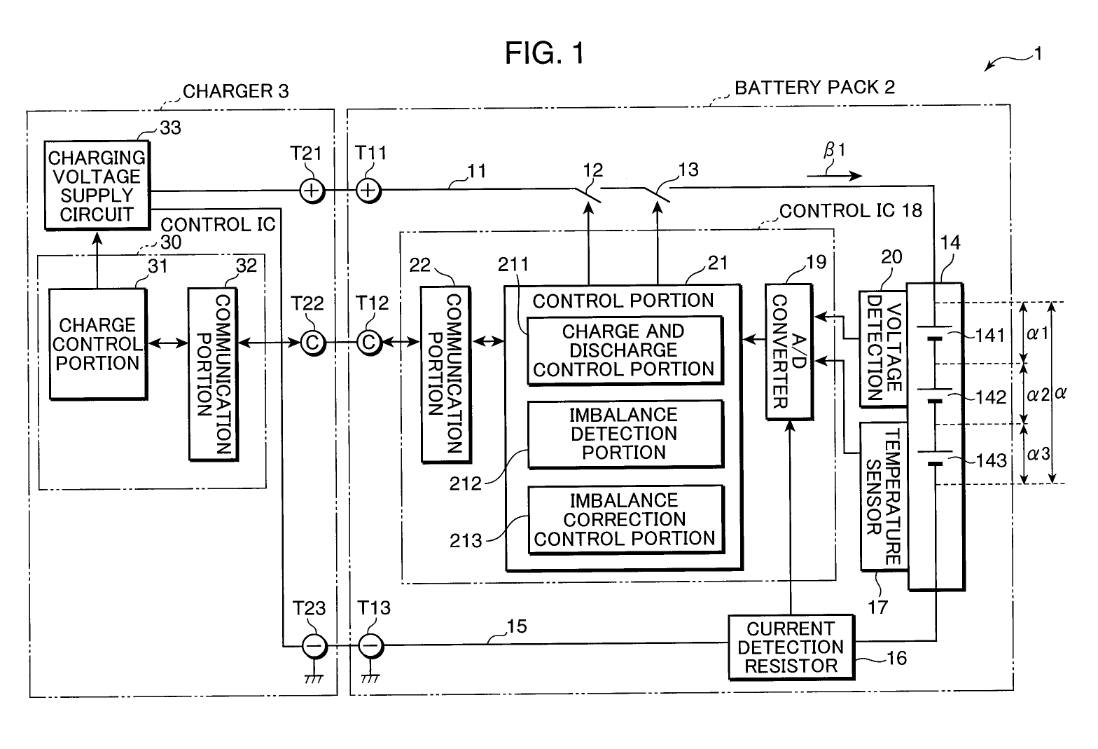

Hereinafter, an embodiment of the invention will be described on the basis of the drawings. In the respective drawings, components labeled with the same reference numerals denote the same components and descriptions of such components are omitted. FIG. 1 is a block diagram showing an example of the configuration of a power supply system according to one embodiment of the invention. A power supply system 1 includes a battery pack 2 and a charger 3 that charges the battery pack 2. Alternatively, an electrical device may be formed by further including an unillustrated load device to which power is fed from the battery pack 2. In such a case, although it is shown in FIG. 1 that the battery pack 2 is charged by the charger 3, the battery pack 2 may be attached to the load device so that the battery pack 2 is charged via the load device. The battery pack 2 and the charger 3 are connected to each other with terminals T11 and T21 on the DC high end where power feeding is performed, terminals T12 and T22 for communication signals, and GND terminals T13 and T23 for power feeding and communication signals. In a case where the load device is provided, similar terminals are provided.

Inside the battery pack 2, FETs (Field Effect Transistors) 12 and 13 used for a charge and a discharge and having mutually different conduction types are interposed in a charging path 11 on the DC high end extending from the terminal T11. The charging path 11 is connected to the high end terminal of an assembled battery 14. The low end terminal of the assembled battery 14 is connected to the GND terminal T13 via a charging path 15 on the DC low end. A current detection resistor 16 (current detection portion) that converts a charging current and a discharging current to a voltage value is interposed in the charging path 15.

The assembled battery 14 includes a plurality of secondary batteries 141, 142, and 143 connected in series. Temperatures of the respective secondary batteries are detected by a temperature sensor 17 (temperature detection portion) and inputted into an analog-to-digital converter 19 within a control IC 18. Terminal voltages a1, a2, and a3 across a plurality of the secondary batteries 141, 142, and 143, respectively, are read by a voltage detection circuit 20 (voltage detection portion) and inputted into the analog-to-digital converter 19 within the control IC 18. Further, the current value detected by the current detection resistor 16 is also inputted into the analog-to-digital converter 19 within the control IC 18. The analog-to-digital converter 19 converts respective input values to digital values and outputs the digital values to a control portion 21. It should be noted that it is sufficient for the assembled battery 14 to include a plurality of secondary batteries connected in series and the number of the secondary batteries are not limited to three.

The control portion 21 includes a CPU (Central Processing Unit) that performs, for example, predetermined arithmetic processing, a ROM (Read Only Memory) that pre-stores a predetermined program, a RAM (Random Access Memory) that temporarily stores data, and peripheral circuits. By running the control program pre-stored in the ROM, the control portion 21 functions as a charge and discharge control portion 211, an imbalance detection portion 212, and an imbalance correction control portion 213.

The charge and discharge control portion 211 computes a voltage value and a current value of a charging current requested to be outputted from the charger 3 in response to various input values from the analog-to-digital converter 19 and transmits the computation results to the charger 3 from the communication portion 22 via the terminals T12 and T22 and the terminals T13 and T23. Also, the charge and discharge control portion 211 performs a protective operation, such as interruption of the FETs 12 and 13, against an abnormality on the outside of the battery pack 2, such as a short circuit between the terminals T11 and T13 and an abnormal current from the charger 3, and an abnormal temperature rise in the assembled battery 14 on the basis of the respective input values from the analog-to-digital converter 19.

To be more concrete, in a case where the terminal voltages across the secondary batteries 141, 142, and 143 detected by the voltage detection circuit 20 are below the preset lower limit voltage V_{L}, the charge and discharge control portion 211 turns OFF the FETs 12 and 13 and inhibits a discharge of the assembled battery 14. The lower limit voltage V_{L} is set, for example, to a range of 2.5 to 3.5 V per secondary battery. The lower limit voltage V_{L} exceeding 3.5 V per cell is not preferable because utilization (actual capacity/theoretical capacity) with respect to a theoretical capacity of the positive electrode decreases. Meanwhile, the lower limit voltage V_{L} lower than 2.5V is not preferable, either, because the secondary battery is readily discharged to an overdischarge region.

When the terminal voltages across the secondary batteries 141, 142, and 143 detected by the voltage detection circuit 20 reach or exceed a charge forced stopping voltage set to a voltage higher than a preset set voltage Vs, the charge and discharge control portion 211 turns OFF the FETs 12 and 13 or transmits a charge stop request to the charger 3 from the communication portion 22 and inhibits a charge of the assembled battery 14. The set voltage Vs is set, for example, to 4.35 V, which is a voltage lower than a voltage (for example, 4.6 V) at which the electrolyte of the secondary batteries 141, 142, and 143 starts to decompose.

As will be described below, the terminal voltages across the secondary batteries 141, 142, and 143 do not exceed the set voltage Vs during a normal charge owing to the voltage suppressing effect exerted by deposited lithium (deposited metal) in the secondary batteries 141, 142, and 143 described below. However, in order to ensure the safety in the event that the terminal voltage exceeds the set voltage Vs because of a damage of a heat resistant porous protective membrane (porous heat resistant layer) described below, it is preferable to inhibit a charge when the terminal voltage reaches or exceeds the charge forced stopping voltage.

The charge forced stopping voltage is set in such a manner that a difference from the set voltage Vs falls, for example, within a range of 0.1 to 0.3 V for each of the secondary batteries 141, 142, and 143. When a difference between the charge forced stopping voltage and the set voltage Vs exceeds 0.3 V per cell, the safety in the event of a discharge is lowered. Meanwhile, when a difference between the charge forced stopping voltage and the set voltage Vs is smaller than 0.1 V, the margin with the set voltage Vs becomes so small that there is a risk of failing to forcedly stop a charge even during a normal charge. Neither is therefore preferable.

Also, when the temperatures of the secondary batteries 141, 142, and 143 detected by the temperature sensor 17 exceed a predetermined charge stopping temperature Tₛ, the charge and discharge control portion 211 inhibits a charge of the secondary batteries 141, 142, and 143. The charge and discharge control portion 211 sets the charge stopping temperature Tₛ at which a charge is stopped to a temperature, for example, 10 to 30° C. higher than the ambient temperature detected by an unillustrated temperature sensor.

As will be described below, because a charging current at a predetermined value flows to a short-circuited point caused by deposited lithium in the vicinity of the set voltage Vs in the secondary batteries 141, 142, and 143, a charge is accompanied by heat generation (Joule heat). In a case where the heat is generated excessively, the positive electrode active material lacking thermal stability is heated unnecessarily, which is not preferable. Accordingly, it is preferable to dispose the temperature sensor 17 in close proximity to the secondary batteries 141, 142, and 143 so that a charge is stopped when the temperature measured by the temperature sensor 17 exceeds the charge stopping temperature T_{S}.

When the charge stopping temperature T_{S} exceeds a temperature as high as the ambient temperature plus 30° C., the foregoing concerns become evident. Meanwhile, when the charge stopping temperature T_{S} is below a temperature as high as the ambient temperature plus 10° C., a charge is stopped even by slight heat generation caused by a factor, such as a case where the terminal voltages across the secondary batteries 141, 142, and 143 do not rise in close proximity to the set voltage Vs. Neither is therefore preferable.

In a case where the terminal voltages α1, α2, and α3 across the secondary batteries 141, 142, and 143, respectively, inputted from the analog-to-digital converter 19 satisfy a preset specific determination condition, the imbalance detection portion 212 determines the occurrence of an imbalance in a charge state in the secondary batteries 141, 142, and 143.

When the occurrence of an imbalance is determined by the imbalance detection portion 212, the imbalance correction control portion 213 requests a voltage (for example, 4.35×3=13.05 V) found by multiplying 4.35 V, which is the preset set voltage Vs higher than the cut-off voltage of charge, Vf (for example, 4.2 V), for the constant voltage charge and lower than a voltage (for example, 4.6 V) at which the electrolyte starts to decompose, by the number of series cells, from the charger 3, so that the assembled battery 14 is charged at 13.05 V. The set voltage Vs is, for example, preferably 3.8 V to 4.4 V.

In the charger, 3, the request is received at a communication portion 32 serving as communication means in a control IC 30 and a charge control portion 31 serving as charge control means controls a charging voltage supply circuit 33 (charging voltage supply portion) serving as charging current supply means to supply a charging current at the voltage value specified above, a current value, and a pulse width. The charging voltage supply circuit 33 is formed of an AC-DC converter or a DC-DC converter and converts an input voltage to a voltage value, a current value, and a pulse width specified by the charge control portion 31 and supplies the result to the charging paths 11 and 15 via the terminals T21 and T11 and the terminals T23 and T13, respectively.

It should be appreciated that the invention is not limited to a case where the control portion 21 is provided to the battery pack 2 and the control portion 21 may be provided to the charger 3.

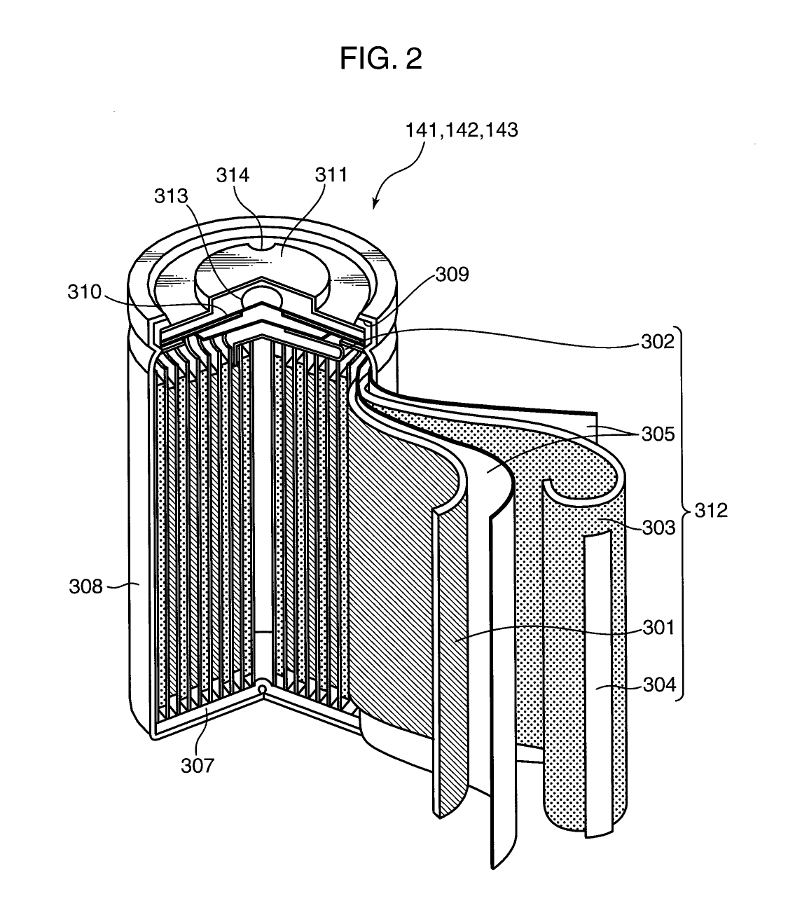

FIG. 2 is schematic cross section showing an example of the configuration of the secondary batteries 141, 142, and 143. The secondary batteries 141, 142, and 143 shown in FIG. 2 are cylindrical nonaqueous electrolyte secondary batteries each having an electrode plate group of a spiral structure, for example, lithium-ion secondary batteries. An electrode plate group 312 has a structure in which a positive electrode plate 301 provided with a positive electrode lead current collector 302 and a negative electrode plate 303 provided with a negative electrode lead current collector 304 are wound in a spiral pattern with a separator 305 in between. Also, an unillustrated porous protective membrane is formed between the negative electrode plate 303 and the separator 305.

An unillustrated top insulating plate and a bottom insulating plate 307 are attached, respectively, to the top and the bottom of the electrode plate group 312. The electrode plate group 312 and an unillustrated nonacqueous electrolyte (electrolyte) are placed in a case 308 that is sealed with a gasket 309, a sealing plate 310, and a positive electrode terminal 311.

A substantially circular groove 313 is formed almost at the center of the sealing plate 310. Accordingly, when a gas is generated inside the case 308 and the internal pressure exceeds a predetermined pressure, the groove 313 breaks to release the gas inside the case 308. Also, a convex portion for external connection is provided almost at the center portion of the positive electrode terminal 311 and an electrode opening portion 314 is provided to this convex portion. Accordingly, when the groove 313 breaks to release a gas, the gas is released to the outside of the secondary batteries 141, 142, and 143 through the electrode opening portion 314.

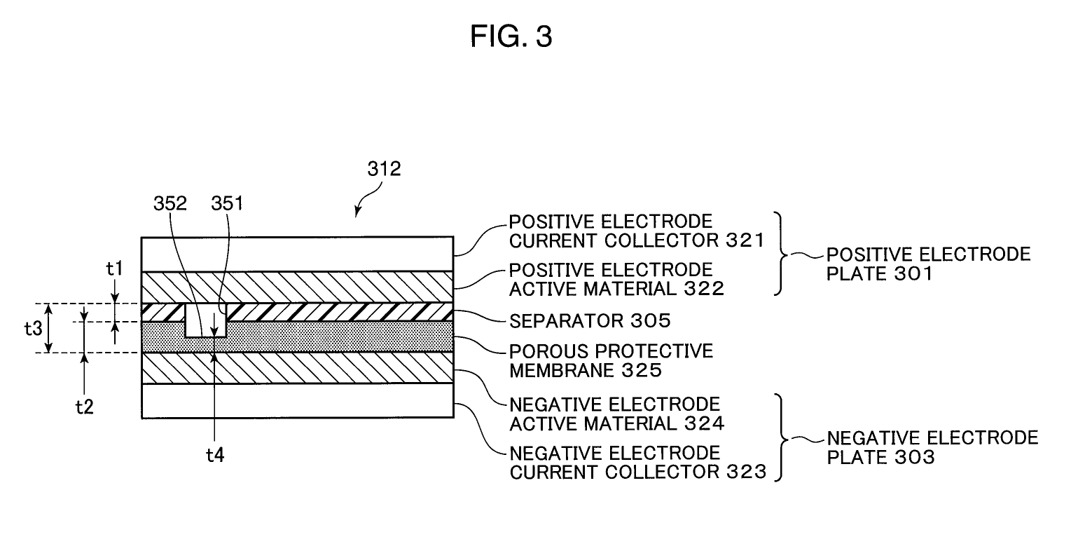

FIG. 3 is a cross section showing the configuration of the electrode plate group 312 in detail. The electrode plate group 312 shown in FIG. 3 is formed by layering a negative electrode current collector 323, a negative electrode active material 324, a porous protective membrane 325 (heat resistant member), a separator 305, a positive electrode active material 322, and a positive electrode current collector 321 sequentially in this order.

The positive electrode plate 301 shown in FIG. 3 is formed by coating the surface of the positive electrode current collector 321 made of metal foil, for example, aluminum foil, with the positive electrode material 322 almost evenly. The positive electrode active material 322 contains a transition metal containing complex oxide that contains lithium, for example, a transition metal containing complex oxide, such as LiCoO₂ and LiNiO₂ used in a nonaqueous electrolyte secondary battery, as the positive electrode active material. Of these transition metal containing complex oxides, a transition metal containing complex oxide in which a part of Co is replaced with another element is preferable because a high cut-off voltage of charge can be used and a satisfactory covering membrane can be formed through adhesion or decomposition of an additive on the surface in a high voltage state. To be more concrete, examples of such a transition metal containing complex oxide include but not limited to transition metal containing complex oxides expressed by a general formula, LiₐM_{b}Ni_{c}CO_{d}Oₑ (where M is at least one type of metal selected from the group consisting of Al, Mn, Sn, In, Fe, Cu, Mg, Ti, Zn, and Mo, 0<a<1.3, 0.02≦b≦0.5, 0.02≦d/c+d 0.9, 1.8<e<2.2, b+c+d=1, and 0.34<c). In particular, it is preferable that M in the general formula is at least one type of metal selected from the group consisting of Cu and Fe.

The negative electrode plate 303 shown in FIG. 3 is formed by coating the surface of the negative electrode current collector 323 made of metal foil, such as aluminum foil, with the negative electrode active material 324 almost evenly.

As the negative electrode active material 324, a material capable of reversely inserting and extracting lithium, such as a carbonaceous material, a lithium containing complex oxide, and a material that can be alloyed with lithium, and metal lithium are available. Example of the carbonaceous material include but not limited to coke, pyrolytic carbons, natural graphite, artificial graphite, meso carbon microbeads, a graphitized mesophase microsphere, vapor-growth carbon, vitreous carbons, carbon fiber (based on polyacrylonitrile, pitch, cellulose, and vapor-growth carbon), amorphous carbon, and a carbonaceous material made of burned organics. These examples can be used either solely or in the form of a mixture of two or more types. Of these examples, a graphite material, such as a carbonaceous material made of graphitized mesophase microspheres, natural graphite, and artificial graphite, are preferable. Also, examples of a material that can be alloyed with lithium include but not limited to a Si simple substance and a compound of Si and O(SiOₓ). These examples can be used either solely or in the form of a mixture of two or more types. By using the silicon-based negative electrode active material as above, it becomes possible to obtain a nonaqueous electrolyte secondary battery having a further larger capacity.

As the separator 305 shown in FIG. 3, an insulating microporous thin membrane having a high ion permeation rate and predetermined mechanical strength is used. Also, it is preferable that the separator 305 is based on a resin material having a melting point of 200° C. or below. In particular, polyolefin is used preferably. Among available materials, polyethylene, polypropylene, an ethylene-propylene copolymer, a complex of polyethylene and polypropylene are preferable. This is because a separator made of polyolefin having a melting point of 200° C. or below can readily melt in a case where the battery is short-circuited due to an external factor. The separator can be a mono-layer membrane made of one type of polyolefin resin or a multi-layer membrane made of two or more types of polyolefin resin. A thickness t1 of the separator is not particularly limited. However, 8 to 30 μm is preferable from the standpoint of maintaining a design capacity of the battery.

The separator 305 is provided with a hole 351 and a part of the separator 305 is therefore removed. This configuration allows lithium ions to migrate by bypassing the separator 305.

The porous protective membrane 325 (porous heat resistant layer) shown in FIG. 3 is formed, for example, by preparing a coating material (hereinafter, referred to as the porous membrane coating material) containing an inorganic oxide filler and a resin binder and by coating the surface of the negative electrode plate 303 with the porous membrane coating material followed by drying. Consequently, the porous protective membrane 325 is provided in close contact with the surface of the negative electrode plate 303.

The porous membrane coating material can be obtained by mixing an inorganic oxide filler and a resin binder with a dispersion medium of the filler. As the dispersion medium, an organic solvent, such as N-methyl-2-pyrrolidone (NMP) and cyclohexanone, or water is preferably used. It should be appreciated, however, that the dispersion medium is not limited to these preferable examples. The filler, the resin binder, and the dispersion medium can be mixed using a dual-arm stirring machine, such as a planetary mixer, or a wet disperser, such as a bead mill. Examples of a method of coating the electrode surface with the porous membrane coating material include but not limited to the comma roll method, the gravure roll method, and the die coating method.

For the porous protective membrane 325, it is sufficient that a fine-particle slurry containing a resin binder and an inorganic oxide filler is applied to the surface of at least one of the negative electrode and the positive electrode. Also, the porous protective membrane 325 is not limited to an example formed on the surface of the negative electrode plate 303 and it may be formed on the surface of the positive electrode plate 301 or formed oppositely on the surfaces of both the positive electrode plate 301 and the negative electrode plate 303. Also, a thickness t2 of the porous protective membrane 325 is preferably in a range of 0.1 μm to 200 μm.

From the standpoint of obtaining the porous protective membrane 325 having high heat resistance, it is preferable that an inorganic oxide filler has the heat resistance (melting point) against 250° C. or higher and is electrochemically stable within a potential window of the nonaqueous electrolyte secondary battery. Most of inorganic oxide fillers satisfy these conditions and alumina, silica, zirconia, and titania are preferable among inorganic oxides. In particular, it is preferable to select the inorganic oxide from alumina powder or SiO₂ powder (silica) having a particle diameter in the range of 0.1 μm to 50 μm. The inorganic oxide fillers can be used solely or in the form of a mixture of two or more types.

From the standpoint of obtaining the porous protective membrane 325 having satisfactory ionic conductivity, it is preferable that a bulk density (tap density) of the inorganic oxide filler is in a range of 0.2 g/cm³ to 0.8 g/cm³ both inclusive. When the bulk density is lower than 0.2 g/cm³, the inorganic oxide filler becomes so bulky that the porous protective membrane 325 may possibly have a fragile structure. Meanwhile, when the bulk density exceeds 0.8 g/cm³, it may become difficult to form a suitable clearance among filler particles. Although the particle diameter of the inorganic oxide filler is not particularly limited, the bulk density becomes lower as the particle diameter becomes smaller. A particle shape of the inorganic oxide filler is not particularly limited, either. It is, however, preferable that particles are amorphous particles made up of a plurality (for example, two to ten and preferably three to five) of fixedly coupled primary particles. Because primary particles are normally made of a single crystal, amorphous particles become polycrystalline particles without exception.

An amount of the resin binder contained in the porous protective membrane 325 is preferably in a range of 1 part by weight to 20 parts by weight both inclusive on the basis of 100 parts by weight of the inorganic oxide filler and a range of 1 part by weight to 5 parts by weight both inclusive is further preferable. When an amount of the resin binder exceeds 20 parts by weight, many of fine pores in the porous protective membrane 325 are clogged with the resin binder and the discharge characteristic may possibly be deteriorated. Meanwhile, when an amount of the resin binder is less than 1 part by weight, adhesiveness between the porous protective membrane 325 and the electrode surface is deteriorated, which may possibly cause separation of the porous protective membrane 325.

From the standpoint of maintaining thermal stability of the porous protective membrane 325 even when the temperature rises at a point at which an internal short circuit is occurring, it is preferable that the melting point and the pyrolysis temperature of the resin binder are 250° C. or higher. Also, in a case where the resin binder is made of crystalline polymers, it is preferable that the melting point of the crystalline polymers is 250° C. or higher. It should be noted, however, that because the chief component of the porous protective membrane 325 is an inorganic oxide having high heat resistance, the heat resistance of the porous protective membrane 325 does not significantly depend on the heat resistance of the resin binder. Hence, because the heat resistance of the porous protective membrane 325 is substantially determined by the heat resistance of the inorganic oxide filler, even when the melting point or the pyrolysis temperature of the resin binder is below 250° C., the porous protective membrane 325 as a whole comes to have the heat resistance (melting point) substantially against 250° C. or higher.

As the resin binder, styrene butadiene rubber (SBR), denatured SBR containing an acrylic acid unit or an acrylate unit, polyethylene, polytetrafluoroethylene (PTFE), polyvinylidene fluoride (PVDF), a tetrafluoroethylene-hexafluoropropylene copolymer (FEP), a polyacrylic acid derivative, and a polyacrylonitrile derivative are available.

Also, resin dissolvable in an organic solvent, for example, polyvinylidene fluoride (PVDF), and polymers, such as various adhesive rubber particles (for example, those available from Zeon Corporation under the product name of BM-500B), dispersible in an organic solvent or water are available as the resin binder.

These resin binders can be used either solely or in combination of two or more types. Of these resin binders, a polyacrylic acid derivative and a polyacrylonitrile derivative are particularly preferable. It is preferable that these derivatives contain at least one type selected from the group consisting of a methyl acrylate unit, an ethyl acrylate unit, a methyl methacrylate unit, and an ethyl methacrylate unit in addition to an acrylic acid unit and/or an acrylonitrile unit.

In a case where rubber particles (for example, SBR or denatured SBR) are used as the resin binder, it is preferable that the resin binder further contains a thickening agent. It is typical to select polymers soluble to a dispersion medium of the porous membrane coating material as the thickening agent. As such a thickening agent, PVDF and carboxymethyl cellulose (CMC) are available. Denatured acrylonitrile rubber or the like dissolvable in the dispersion medium is also available.

From the standpoint of preventing deterioration of the discharge characteristic caused by the swelling of the porous insulating film, it is preferable to set a fine pore diameter D90 when the accumulated volume is 90% to 0.15 μm or larger in a fine pore diameter distribution of the porous insulating membrane measured by a mercury intrusion porosimeter. The fine pore diameter distribution represents, for example, the relation of the fine pore diameter and a volume (frequency) occupied by pores having the fine pore diameter. The accumulated volume is calculated by adding up the volumes of the fine pores sequentially from those having smaller fine pore diameters to larger fine pores.

In a case where the fine pore diameter D90 is 0.15 μm or larger, it is thought that fine pores necessary to ensure the ionic conductivity can be left in the porous insulating membrane even when the resin binder in the porous insulting membrane has swollen with a nonaqueous electrolyte. In a case where the fine pore diameter D90 is smaller than 0.15 μm, smaller fine pores account for too large a proportion of the total fine pores in the porous insulating membrane and the porous insulating membrane is susceptible to the swelling of the resin binder. From the standpoint of further reducing the influences of the swelling of the resin binder, the fine pore diameter D90 is preferably 0.2 μm or larger. It should be noted, however, that when the fine pore diameter D90 becomes too large, fine pores account for an excessively large proportion in volume of the porous insulating membrane and the structure of the porous insulating membrane becomes fragile. In view of the foregoing, the fine pore diameter D90 is preferably 2 μm or smaller.

From the viewpoint of achieving the fine pore diameter distribution described above, it is preferable to set an amount of the resin binder contained in the porous insulating membrane to 4 parts by weight or less on the basis of 100 parts by weight of the inorganic oxide filler and it is more preferable to set the amount to 3 parts by weight or less. Unless an amount of the resin binder placed in clearances of the inorganic oxide filler is small, it is difficult to make the fine pore diameter D90 to 0.15 μm or larger. Also, by suppressing an amount of the resin binder placed in clearances of the inorganic oxide filler to be small, it becomes possible to suppress the swelling of the porous insulating membrane effectively. Meanwhile, from the standpoint of avoiding separation and fall-off of the porous insulating membrane from the electrode surface, an amount of the resin binder is preferably 1 part by weight or more on the basis of 100 parts by weight of the inorganic oxide filler.

From the standpoint of achieving the fine pore diameter distribution described above, it is preferable that the inorganic oxide filler contains polycrystalline particles having a dendritic shape, a coralloid shape, or a tufted shape. Because such polycrystalline particles hardly form an excessively dense packing structure within the porous insulating membrane, they are suitable to form moderate clearances. Polycrystalline particles include, for example, particles made up of about two to ten primary particles coupled by fusing and particles made up of about two to ten particles united in the middle of crystalline growth by contact.

The mean particle diameter of primary particles forming the polycrystalline particles is preferably 3 μm or smaller and more preferably 1 μm or smaller. When the mean particle diameter of the primary particles exceeds 3 μm, the resin binder becomes excessive with a decrease of the surface area of the filler, and the swelling of the porous insulating membrane with the nonaqueous electrolyte may readily occur. In a case where the primary particles are not identified clearly in the polycrystalline particles, the particle diameter of the primary particles is defined by the thickest portion of the knot in the polycrystalline particles.

The mean particle diameter of the primary particles can be found by measuring particle diameters of at least ten primary particles, for example, from an SEM image or a TEM image of the polycrystalline particles and calculating the average. In a case where the polycrystalline particles are obtained through diffusion bond by applying heat treatment to the primary particles, the mean particle diameter (median diameter on the volume basis: D50) of the primary particles as a raw material can be handled as the mean particle diameter of the primary particles forming the polycrystalline particles. By the heat treatment merely to promote the diffusion bond as above, the mean particle diameter of the primary particles hardly varies.

It is preferable that the mean particle diameter of the polycrystalline particles is two or more times larger than the mean particle diameter of the primary particles and 10 μm or smaller and more preferably 3 μm or smaller. The average particle diameter (median diameter on the volume basis: D50) of the polycrystalline particles can be measured, for example, using a wet laser particle size distribution measurement device available from Micro Track Co., Ltd. When the mean particle diameter of the polycrystalline particles is less than two times larger than the average particle diameter of the primary particles, the porous insulating membrane may possibly have an excessively dense packing structure. When the mean particle diameter exceeds 10 μm, the porosity of the porous insulating membrane becomes too high and the structure of the porous insulating membrane may possibly become fragile.

A method of obtaining the polycrystalline particles is not particularly limited and the polycrystalline particles can be obtained, for example, by sintering inorganic oxides to form a lump and by pulverizing the lump moderately. Alternatively, by allowing particles in the middle of the crystalline growth to come into contact with each other, the polycrystalline particles can be obtained directly by skipping the pulverizing step.

For instance, in a case where the polycrystalline particles are obtained by sintering a-alumina to form a lump and pulverizing the lump moderately, the sintering temperature is preferably 800 to 1300° C. and the sintering time is preferably 3 to 30 minutes. Also, in a case where the lump is pulverized, the lump can be pulverized using wet equipment, such as a ball mill or dry equipment, such as a jet mill and a jaw crusher. In this case, anyone skilled in the art is able to control the polycrystalline particles to have an arbitrary mean particle diameter by adjusting the pulverization condition as needed.

A concave portion 352 is formed in the porous protective membrane 325 at a position opposing the hole 351 and the thickness of the porous protective membrane 325 at the bottom of the concave portion 352 is set to a thickness t4 that is thinner than t2. The concave portion 352 can be formed, for example, by coating the surface of the negative electrode plate 303 with the porous membrane coating material and by embossing the porous membrane coating material before it dries using, for example, a convex protrusion.

The thickness t1 of the separator 305 and the thickness t2 of the porous protective membrane 325 are set as needed. Further, as will be described below, a distance between the negative electrode active material 324 and the positive electrode active material 322, that is, an interval t3 between the negative electrode plate 303 and the positive electrode plate 301, is set in such a manner that deposited lithium is formed to bridge between the negative electrode plate 303 and the positive electrode plate 301 when the predetermined set voltage Vs, for example, 4.35 V, is applied between the negative electrode plate 303 and the positive electrode plate 301. In this case, the interval t3 between the negative electrode plate 303 and the positive electrode plate 301 is set by the separator 305 and the porous protective membrane 325.

By charging the secondary batteries 141, 142, and 143 configured as above to become an overcharge state, lithium ions having migrated from the positive electrode plate 301 to the negative electrode plate 303 are deposited on the surface of the negative electrode plate 303 as metal lithium. Metal lithium deposited on the surface of the negative electrode plate 303 is grown toward the positive electrode plate 301.

In this case, the growth of the deposited metal lithium, that is, deposited lithium, depends on the interval t3 between the negative electrode plate 303 and the positive electrode plate 301, the thickness t4, the porosity P, the tortuosity K of the porous protective membrane 325, and the diameter D of fine pores making the heat resistant member porous. More specifically, deposited lithium is grown more readily as the interval t3 becomes smaller. It is grown more readily as the thickness t4 becomes smaller. It is grown more readily as the porosity P becomes higher. It is grown more readily as the tortuosity becomes lower. It is grown more readily as the diameter D of fine pores making the porous protective membrane 325 porous becomes larger. Accordingly, because the thickness t4 is set smaller than the thickness t2 by the concave portion 352, deposited lithium can be grown readily in the concave portion 352.

Also, by providing the porous protective membrane 325 in close contact with the surface of the negative electrode plate 303 (or the surface of the positive electrode plate 301), the porous protective membrane 325 (porous heat resistant layer) having no structural strength in a plane direction as with a microporous film conventionally used as the separator, such as the separator 305, can be present in a stable manner using the negative electrode (or the positive electrode) as the base. In particular, by providing the porous protective membrane 325 on the surface of the negative electrode, it comes into close contact with the negative electrode. Hence, when an amount of charging electricity becomes excessive, lithium dendrites are allowed to reach to the surface of the positive electrode from the surface of the negative electrode by way of the porous protective membrane 325 in almost the shortest path without coming into contact with an excessive electrolyte. It is therefore possible to lower the risk that chemically active lithium dendrites come into contact with an excessive electrolyte and become inactive by chemically turning into lithium oxide or lithium carbonate.

A resin microporous film conventionally used as a separator in a lithium-ion secondary battery has no holes large enough for deposited lithium to be grown, and the growth of deposited lithium is interrupted by the separator. Hence, unless a pin hole is made in the separator, for example, by poor fabrication or entrance of foreign matter between the electrodes, deposited lithium will not penetrate through the separator to cause a short circuit between the positive and negative electrodes.

By contrast, the hole 351 is made in the separator 305 in the secondary batteries 141, 142, and 143. Accordingly, deposited lithium grown in the concave portion 352 is allowed to reach the positive electrode plate 301 by penetrating through the hole 351.

Deposited lithium is grown more readily as a voltage applied between the negative electrode plate 303 and the positive electrode plate 301 in an overcharge state becomes higher and is grown less readily as the voltage becomes lower. Hence, the secondary batteries 141, 142, and 143 are configured in such a manner that deposited lithium is bridged between the negative electrode plate 303 and the positive electrode plate 301 to cause a short circuit when a voltage applied between the negative electrode plate 303 and the positive electrode plate 301 reaches the set voltage Vs, for example, 4.35 V, by setting the interval t3 and the thickness t4, the porosity P, the tortuosity K of the porous protective membrane 325 as well as the diameter D of fine pores making the heat resistant member porous as needed. In this case, the porous protective membrane 325 corresponds to an example of the heat resistant member referred to in the appended claims.

It should be appreciated that the heat resistance temperature (melting point) of the heat resistant member is not necessarily limited to 250° C. or higher. It is sufficient that the heat resistant member does not melt with heat generated by a short circuit caused by deposited lithium.

The porosity P of the porous protective membrane can be found by the following method. Initially, a coating material (hereinafter, referred to as the porous membrane coating material) containing an inorganic oxide filler, a resin binder, and a dispersion medium used to disperse the filler is prepared. The porous membrane coating material is applied on metal foil and dried. The dried coating material together with the metal foil is cut out in an arbitrary area and a sample of the porous protective membrane is obtained by removing the metal foil. An apparent volume Va of the porous protective membrane is found from the thickness and the area of the sample thus obtained and the weight of the sample is measured. Subsequently, a true volume Vt of the porous protective membrane is found using the weight of the sample, a true specific gravity of the inorganic filler and the resin binder. The porosity P can be found from the apparent volume Va and the true volume Vt in accordance with Equation (1):

Porosity P=(Va−Vt)/Va (1)

The porosity P can be set to a desired value by setting the size of the inorganic oxide filler, for example, the mean particle diameter and the shape thereof as needed. As has been described, the inorganic oxide filler can be formed in a dendritic shape, a coralloid shape, and a tufted shape by forming the inorganic oxide filler from polycrystalline particles. The porosity P can be set to a desired value by setting such shapes as needed.

The tortuosity K increases as the size of the inorganic oxide filler, for example, the mean particle diameter, becomes larger. Regarding the diameter D of fine pores, deposited lithium is grown more readily as the peak in the fine pore diameter distribution of the porous protective membrane measured by a mercury intrusion porosimeter is larger.

The suitable interval t3 is, for example, about 2.0 to 30 μm. The suitable thickness t4 of the porous protective membrane 325 in the concave portion 352 is, for example, about 2.0 to 30 μm. The suitable porosity P is, for example, about 40 to 65%. The suitable tortuosity K is, for example, about 1.0 to 1.5. The suitable peak in the distribution of the fine pore diameter D is 0.05 to 3.0 μm.

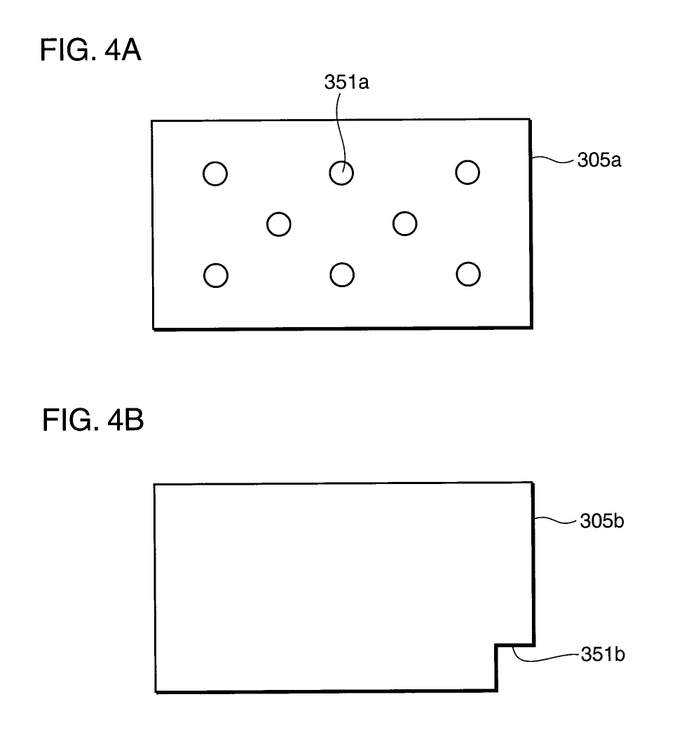

FIG. 4 is a front view showing an example of the separator 305. With the separator 305, a part may be removed by forming holes 351a in a scattered manner, for example, as with a separator 305a shown in FIG. 4A or a part may be removed by providing a notch 351b instead of providing holes as with a separator 305b shown in FIG. 4B.

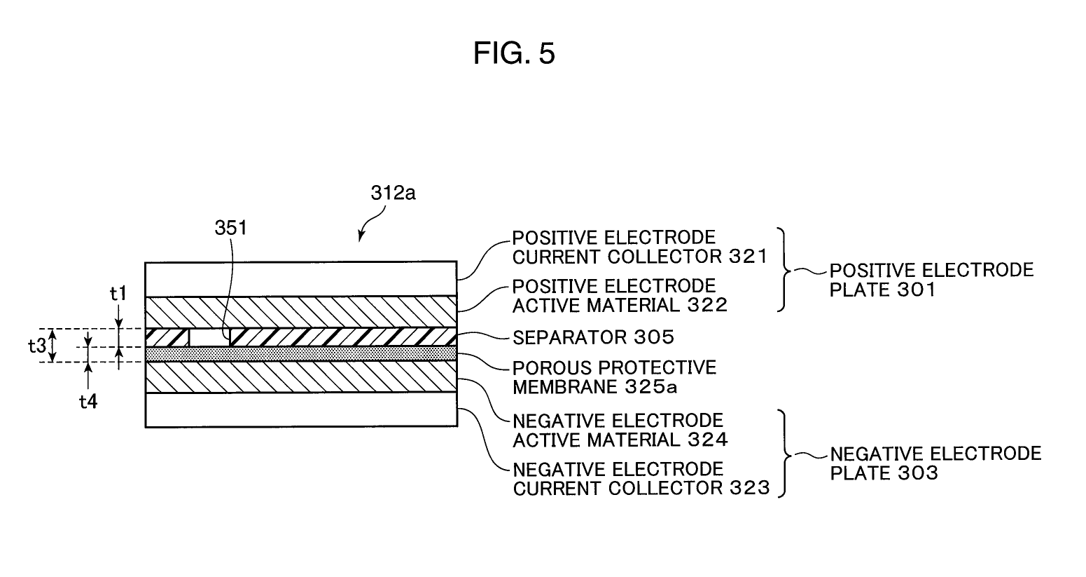

The porous protective membrane 325 may be configured so as not to have the concave portion 352 by providing a porous protective membrane 325a having the thickness t4 originally, for example, as with an electrode plate group 312a shown in FIG. 5.

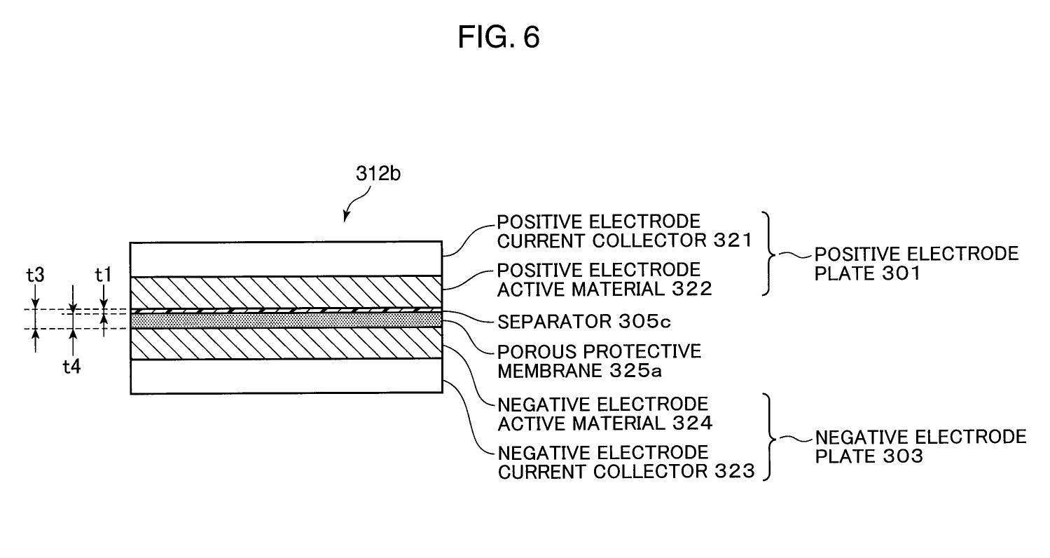

Alternatively, for example, as with an electrode plate group 312b shown in FIG. 6, it may be configured in such a manner that deposited lithium can be grown by penetrating through a separator 305c by reducing the thickness t1 of a separator 305c or setting the porosity, the tortuosity of the separator 305c and the diameter of fine pores making the separator 305c porous as needed.

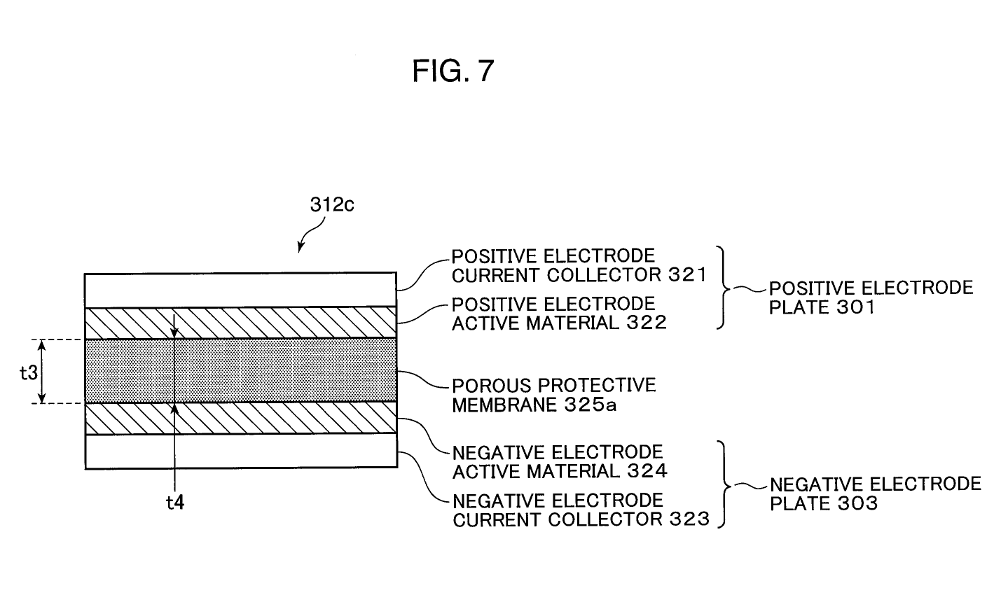

Alternatively, it may be configured in such a manner that the separator 305 is omitted as with an electrode plate group 312c shown in FIG. 7. In this case, the interval t3 between the negative electrode plate 303 and the positive electrode plate 301 is set by the thickness t4 of the porous protective membrane 325a.

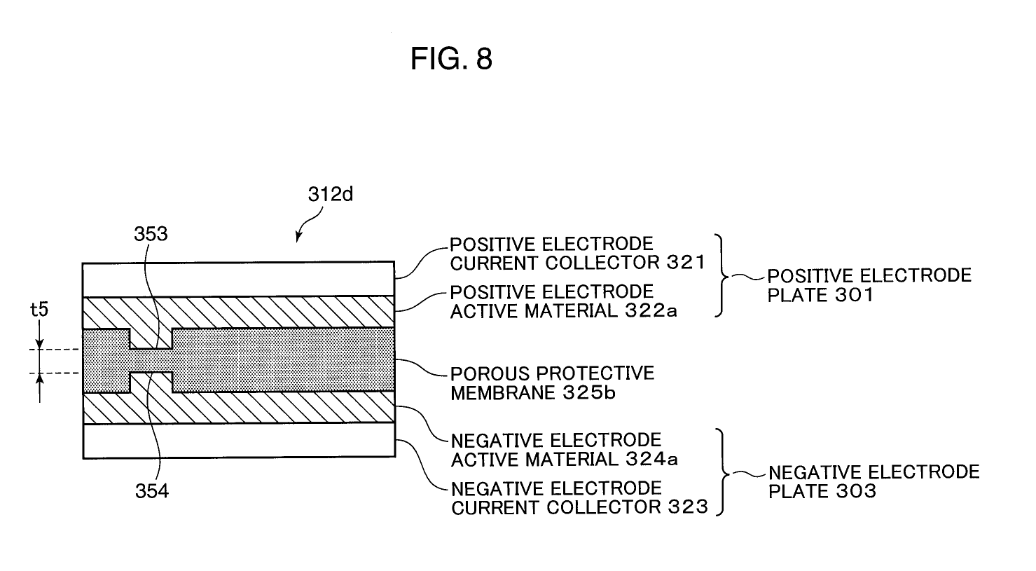

Also, it may be configured in such a manner that the separator 305 is omitted from the configuration of FIG. 3. In this case, the interval t3 between the negative electrode plate 303 and the positive electrode plate 301 is set by the thickness t2 of the porous protective membrane 325. Alternatively, as with an electrode plate group 312d shown in FIG. 8, by providing a convex portion 353 on the layer of a positive electrode active material 322a and a convex portion 354 on the layer of a negative electrode active material 324a and disposing the convex portion 353 and the convex portion 354 oppositely to each other, so that an interval t5 between the convex portion 353 and the convex portion 354 is lessened. In this case, the interval t5 corresponds to the interval t3 between the electrodes and the thickness t4 of a porous protective membrane 325b to control the growth of deposited lithium and the interval t3 between the negative electrode plate 303 and the positive electrode plate 301 is set by the convex portions 354 and 353.

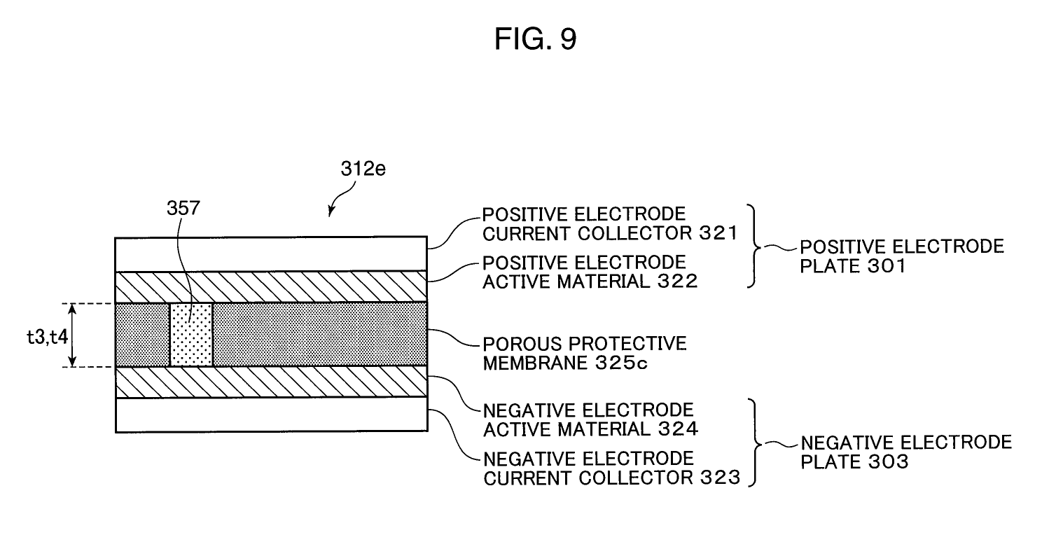

Also, as with an electrode plate group 312e shown in FIG. 9, a growth control portion 357 may be provided instead of the concave portion 352 so as to penetrate through a part of the porous protective membrane 325c and to have a combination of the porosity P, the tortuosity K, and the fine pore diameter D different from those in the other portions. For the growth control portion 357, a combination of the porosity P, the tortuosity K, and the fine pore diameter D is set so that deposited lithium is formed more readily than in the other portions. Also, deposited lithium is bridged between the negative electrode plate 303 and the positive electrode plate 301 to cause a short circuit when a voltage applied between the negative electrode plate 303 and the positive electrode plate 301 reaches the set voltage Vs, for example, 4.35 V.

In this case, the suitable porosity P of the growth control portion 357 is, for example, about 40 to 65%. The suitable tortuosity K of the growth control portion 357 is, for example, about 1.0 to 1.5. The suitable peak in the distribution of the fine pore diameter D of the growth control portion 357 is 0.05 to 3.0 μm. For the portions of the porous protective membrane 325c other than the growth control portion 357, the suitable porosity P is, for example, about 35 to 45%, the suitable tortuosity K is, for example, about 1.5 to 2.5, and the suitable peak in the distribution of the fine pore diameter D is 0.01 to 0.05 μm.

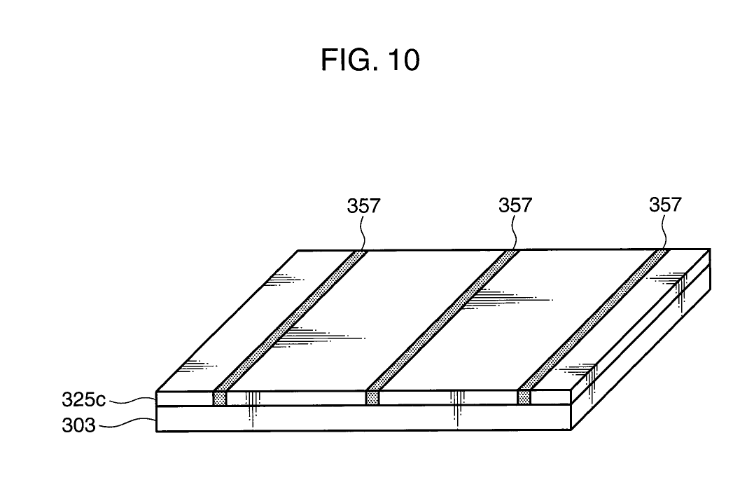

The growth control portion 357 may be, for example, of a circular cylindrical shape. For example, as is shown in FIG. 10, each may extend in the shape of a strip so as to traverse the porous protective membrane 325c or in any of other various shapes. Also, the growth control portion 357 may be provided to more than one point in a scattered manner or to only one point.

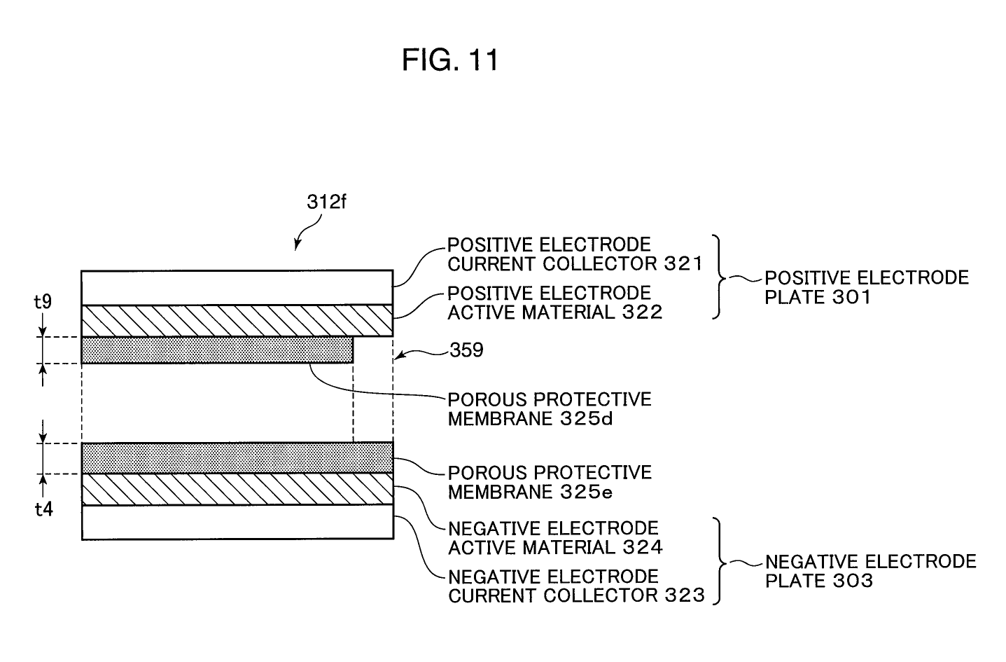

Also, for example, as is shown in FIG. 11, an electrode plate group 312f may be formed by forming a porous protective membrane 325d having a thickness t9 on the surface of the positive electrode plate 301 except for a part, forming a porous protective membrane 325e having the thickness t4 to cover the entire surface of the negative electrode plate 303, and by laminating the porous protective membrane 325d and the porous protective membrane 325e.

In this case, the interval t3 between the negative electrode plate 303 and the positive electrode plate 301 is obtained as a sum of the thickness t4 and the thickness t9.

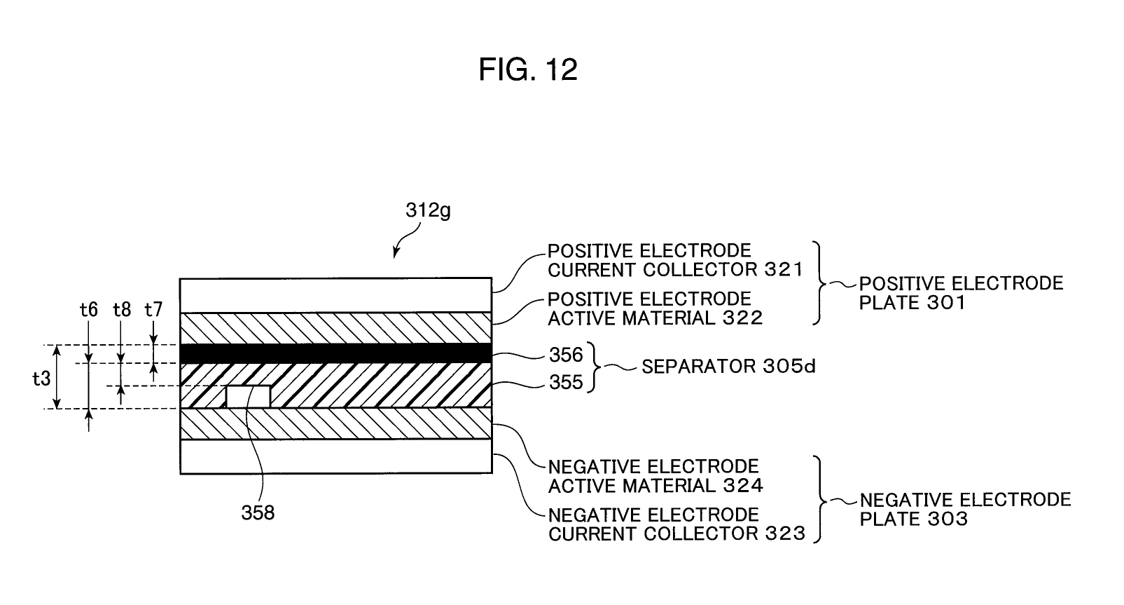

Instead of providing the porous protective membrane 325, for example, a heat resistant separator may be used as with an electrode plate group 312g shown in FIG. 12. A heat resistant separator 305d shown in FIG. 12 is formed, for example, by providing an aramid resin layer 355, which is a heat resistant material having the melting point of 250° C. or higher, on the surface of a substrate 356 made of polyethylene. A thickness t6 of the substrate 355 made of polyethylene is about 14 μm and a thickness t7 of the aramid resin layer 356 is about 3 to 4 pin. Accordingly, the heat resistance of the heat resistant separator 305d is substantially against 250° C. or higher. Hence, even when a short circuit occurs because of deposited lithium, the entire heat resistant separator 305d does not melt with generated heat. Herein, the aramid resin layer 356 itself corresponds to one separator.

The substrate 355 made of polyethylene is provided with a concave portion 358 and a thickness t8 at the bottom of the concave portion 358 is made smaller than t6, so that deposited lithium is readily grown. The thickness t8 is set, for example, 10 μm or smaller. The concave portion 358 can be formed by forming the substrate 355 by laminating, for example, a sheet made of polyethylene having no holes to a sheet having a hole.

The electrode plate group 312g as above is configured in such a manner that a short circuit occurs between the negative electrode plate 303 and the positive electrode plate 301 by deposited lithium in a case where a voltage applied between the negative electrode plate 303 and the positive electrode plate 301 reaches the set voltage Vs, for example, 4.35 V by setting the interval t3 between the negative electrode plate 303 and the positive electrode plate 301, the thickness t8, the porosity P, and the tortuosity K of the separator 305d and the diameter D of pores making the separator 305d porous as needed. In this case, the separator 305d corresponds to an example of the heat resistant member referred to in the appended claims.

It should be appreciated that the separator 305d is not limited to an example provided with the concave portion 358. It may be provided with a hole having an opening area, for example, of 25 mm² or smaller instead of the concave portion 358. The concave portion 358 or the hole may be provided to the separator 305d at more than one point in a scattered manner or at only one point.

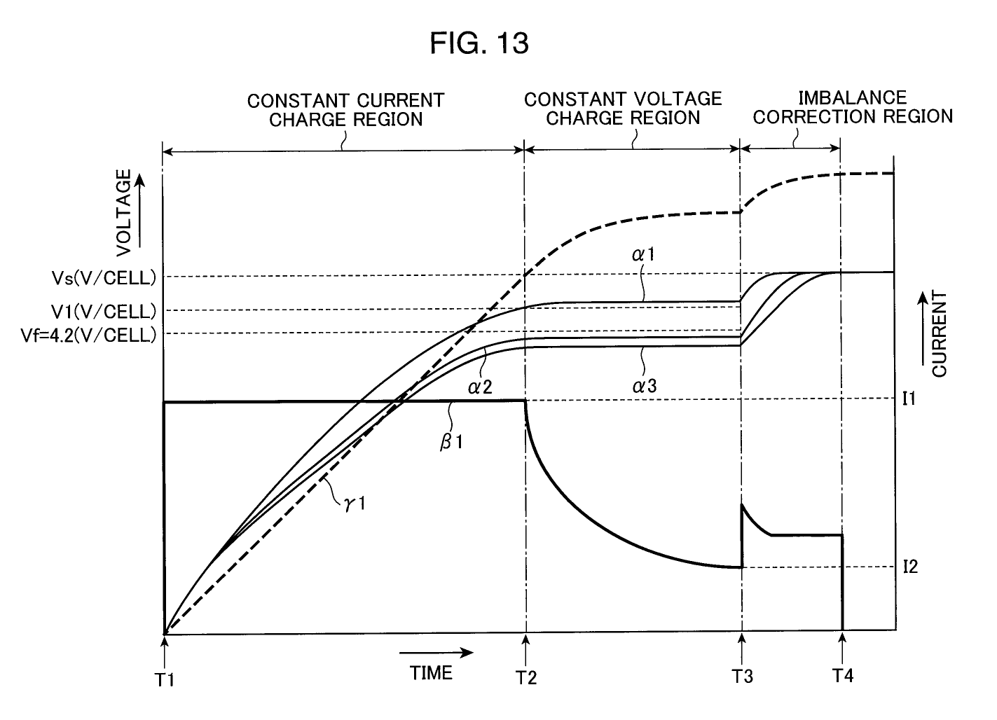

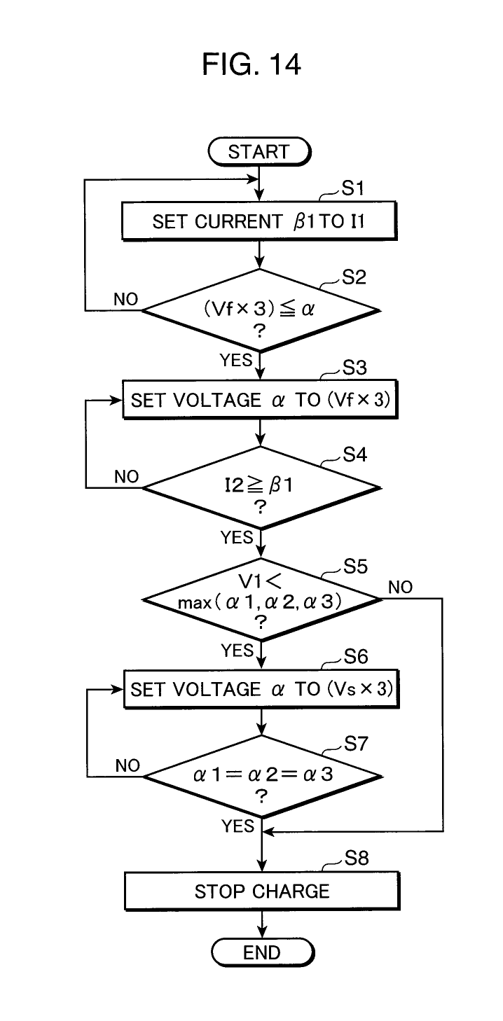

An operation of the power supply system 1 configured as above will now be described. FIG. 13 is a view used to describe an example of the operation of the power supply system 1 according to one embodiment of the invention. FIG. 14 is a flowchart showing an example of the operation of the power supply system 1 according to one embodiment of the invention. Initially, a charge is started at timing T1. Then, in Step S1, a request to output a current at a current value I1 preset as a current for a constant current charge is sent to the charger 3 by the charge and discharge control portion 211, and a current β1 at the current value I1 is supplied to the assembled battery 14 from the charging voltage supply circuit 33 according to a control signal from the charge control portion 31, so that a constant current charge is started (timing T1).

Accordingly, the assembled battery 14 is charged at the current value I1 and a state of charge γ1 of the assembled battery 14 increases gradually. In this instance, the degree of deterioration differs among the secondary batteries 141, 142, and 143. For example, assume that the secondary battery 141 is deteriorated most followed by the secondary batteries 142 and 143. Then, the terminal voltage α1 across the secondary battery 141 is the highest followed by the terminal voltages a2 and a3 in descending order of terminal voltage. As the charge progresses, differences among the terminal voltages α1, α2, and α3 are increased.

Subsequently, the terminal voltage α (=α1+α2+α3) across the assembled battery 14 obtained by the analog-to-digital converter 19 is compared with a voltage equal to the cut-off voltage of charge, Vf, per secondary battery multiplied by the number of secondary batteries, that is, Vf×3, by the imbalance detection portion 212 (Step S2). The cut-off voltage of charge, Vf, is set, for example, to 4.2 V.

When the result of comparison by the imbalance detection portion 212 indicates that the terminal voltage α across the assembled battery 14 is smaller than the cut-off voltage of charge, Vf,×3 (NO in Step S2), the flow returns to Step S1 to continue the constant current charge. Meanwhile, when the terminal voltage a reaches or exceeds the cut-off voltage of charge, Vf,×3 (YES in Step S2), the constant current charge is ended and the flow proceeds to Step S3.

Subsequently, in Step S3, a request to output a voltage equal to the cut-off voltage of charge, Vf, multiplied by the number of secondary batteries, that is, a voltage equal to the cut-off voltage of charge, Vf,×3, to the charger 3 by the charge and discharge control portion 211, and a voltage equal to the cut-off voltage of charge, Vf,×3 is outputted from the charging voltage supply circuit 33 according to a control signal from the charge control portion 31, so that a constant voltage charge is started (timing T2).

Accordingly, a voltage equal to the cut-off voltage of charge, Vf,×3 is applied to the assembled battery 14. The charging current β1 then decreases gradually and the state of charge γ1 of the assembled battery 14 increases gradually. In association with an increase of the state of charge γ1, differences among the terminal voltages α1, α2, and α3 increase gradually.

Subsequently, the current β1 obtained by the analog-to-digital converter 19 is compared with a current value I2 by the charge and discharge control portion 211 (Step S4). When the current β1 exceeds the current value I2 (NO in Step S4), the flow returns to Step S3 to continue the constant voltage charge. Meanwhile, when the current β1 is equal to or below the current value I2 (YES in Step S4), the constant voltage charge is ended and the flow proceeds to Step S5 in order to check whether an imbalance is occurring in a charge state of the secondary batteries 141, 142, and 143.

Subsequently, in Step S5, the determination condition is confirmed by the imbalance detection portion 212 as to whether the maximum value of the terminal voltages a1, a2, and a3 obtained by the analog-to-digital converter 19 exceeds a voltage higher than Vf, for example, an imbalance determination voltage V1 set preliminarily to 4.25 V (Step S5). In a case where the maximum value of the terminal voltages a1, a2, and a3 is equal to or smaller than the imbalance determination voltage V1 (NO in Step S5), the imbalance detection portion 212 determines that an imbalance is not occurring and the flow proceeds to Step S8 to end the charge. Meanwhile, in a case where the maximum value of the terminal voltages a1, a2, and a3 exceeds the imbalance determination voltage V1 (YES in Step S5), the imbalance detection portion 212 determines that an imbalance is occurring and the flow proceeds to Step S6 to correct the imbalance.

It should be appreciated that the invention is not limited to a case where the condition to determine the occurrence of an imbalance when the maximum value of the terminal voltages α1, α2, and α3 exceeds the imbalance determination voltage V1 is used as the determination condition by the imbalance detection portion 212. For example, a condition to determine the occurrence of an imbalance when a difference between the maximum and the minimum of the terminal voltages α1, α2, and α3 exceeds a preset voltage, for example, 0.1 V, may be used as the determination condition. Also, a case where the occurrence of an imbalance in a charge state of the secondary batteries 141, 142, and 143 is checked by the imbalance detection portion 212 after the constant voltage charge ended has been described. However, the occurrence of an imbalance may be checked while the constant voltage charge is performed.

Subsequently, in Step S6, by requesting a voltage equal to the set voltage Vs multiplied by the number of series cells (for example, 4.35×3=13.05 V) to the charger 3, the imbalance correction control portion 213 makes the charger 3 charge the assembled battery 14 at 13.05 V (timing T3). The set voltage Vs is preset to 4.35 V, which is a voltage higher than the cut-off voltage of charge, Vf (for example, 4.2 V), and lower than a voltage (for example, 4.6 V) at which the electrolyte starts to decompose.

Accordingly, the terminal voltage α1 across the secondary battery 141 having the highest terminal voltage rises and reaches the set voltage Vs first. Then, deposited lithium is deposited and grown on the negative electrode plate 303 in the secondary battery 141 and reaches the positive electrode plate 301. Deposited lithium is thus bridged between the negative electrode plate 303 and the positive electrode plate 301 and a short circuit occurs. A current then flows into deposited lithium and the terminal voltage a1 across the secondary battery 141 drops instantaneously. Further, deposited lithium generates heat by the current flowing therein and thereby melts and breaks. The terminal voltage α1 across the secondary battery 141 then reaches again the set voltage Vs and deposited lithium is formed to bridge between the negative electrode plate 303 and the positive electrode plate 301. The negative electrode plate 303 and the positive electrode 301 are thus short-circuited. In this manner, when the terminal voltage α1 reaches the set voltage Vs, deposited lithium is formed and broken repetitively. The terminal voltage α1 is thus maintained at the set voltage Vs.

When the negative electrode plate 303 and the positive electrode 301 are short-circuited by deposited lithium, deposited lithium generates heat with a short circuit current. Then, in a conventional lithium-ion secondary battery having no porous protective membranes 325, 325a, or 325b and using a separator that is not heat resistant, the separator melts and undergoes thermal deformation by a short circuit reaction heat of deposited lithium, which enlarges the short-circuited portion. Consequently, the secondary battery may possibly become an extraordinary overheated state.

By contrast, according to the secondary batteries 141, 142, and 143 provided with the electrode plate group 312, 312a, 312b, 312c, 312d, 312e, or 312f, it is possible to suppress melting and thermal deformation of the separator from spreading by the porous protective membrane 325, 325a, 325b, 325c, 325d, or 325e having high heat resistance. Hence, by causing a short circuit with deposited lithium by applying the set voltage Vs between the negative electrode plate 303 and the positive electrode plate 301, it becomes possible to suppress the short circuit portion from spreading while maintaining the terminal voltage α1 at the set voltage Vs.

Also, according to the secondary batteries 141, 142, and 143 provided with the electrode plate group 312g, it is possible to suppress melting and thermal deformation of the separator from spreading owing to the separator 305d having high heat resistance. Hence, by causing a short circuit with deposited lithium by applying the set voltage Vs between the negative electrode plate 303 and the positive electrode plate 301, it becomes possible to suppress the short-circuited portion from spreading while maintaining the terminal voltage α1 at the set voltage Vs.

Also, according to the secondary batteries 141, 142, and 143 provided with the electrode plate group 312, 312a, 312d, 312e, 312f, or 312g, the hole 351, the concave portion 352, the convex portions 353 and 354, the growth control portion 357, the growth control portion 359, and the concave portion 358 are provided in part of the porous protective membrane 325, 325b, or 325c, which is the heat resistant member, the separator 305 or 350d, which is the heat resistant member, the positive electrode plate 301, or the negative electrode plate 303. Accordingly, a region in which deposited lithium is generated is limited and a short-circuited portion caused by deposited lithium will not increase indefinitely.

Because the secondary batteries 141, 142, and 143 having the electrode plate group 312, 312a, or 312b include the separator 305 or 305c having the melting point lower than that of the porous protective membrane 325 or 325a. Hence, for example, when the secondary batteries 141, 142, and 143 are heated from the outside and in a high-temperature state, resin forming the separators 305 or 305c is softened and the fine pore structure is closed. It thus becomes possible to obtain the so-called shutdown effect by which migration of ions is suppressed. Consequently, safety under an extraordinary hot environment can be enhanced.

In this manner, by charging the assembled battery 14 at a voltage equal to the set voltage Vs multiplied by the number of series cells, all the terminal voltages a1, a2, and a3 across the secondary batteries 141, 142, and 143, respectively, become the set voltage Vs. An imbalance among the secondary batteries 141, 142, and 143 can be thus eliminated.

When the terminal voltages a1, a2, and a3 almost coincide (YES in Step S7), the imbalance correction control portion 213 determines that an imbalance among the secondary batteries 141, 142, and 143 has been eliminated. The flow thus proceeds to Step S8 to end the charge.

Subsequently, in Step S8, a request to reduce the charging current to 0 is outputted to the charger 3 by the charge and discharge control portion 211, and the charge is ended by reducing an output current of the charging voltage supply circuit 33 to 0 by the charge control portion 31 (timing T4).

As has been described, according to the power supply system 1 shown in FIG. 1, in a case where an imbalance occurs among the secondary batteries 141, 142, and 143, it becomes possible to eliminate the imbalance by applying a voltage equal to or higher than a voltage found by multiplying the set voltage Vs by the number of series secondary batteries to the assembled battery 14. Also, even when an imbalance occurs in the assembled battery 14 shown in FIG. 1, the imbalance can be eliminated by applying a voltage equal to or higher than a voltage found by multiplying the set voltage Vs by the number of series secondary batteries. Also, even when an imbalance occurs among the secondary batteries 141, 142, and 143 shown in FIG. 1 used in series connection, the imbalance is eliminated by applying a voltage equal to or higher than the set voltage Vs to each secondary battery.

It should be appreciated that the battery pack 2 is not limited to an example provided with the control IC 18 and the like. For example, the assembled battery 14 may be used as the battery pack 2. Also, a case where the set voltage Vs is set to a voltage higher than the cut-off voltage of charge, Vf, has been described. However, the set voltage Vs may be set to a voltage equal to the cut-off voltage of charge, Vf. When a plurality of secondary batteries in each of which the set voltage Vs is set to a voltage equal to the cut-off voltage of charge, Vf, are used in series connection, an imbalance among the respective secondary batteries can be reduced by performing a constant voltage charge at the cut-off voltage of charge, Vf. Accordingly, there is no need to detect an imbalance among the secondary batteries.

Also, the current detection resistor, the temperature sensor, the analog-to-digital converter, the voltage detection circuit, the control portion, the charge control portion, the charging voltage supply circuit, the imbalance detection portion, the imbalance correction control portion can be present either on the side of the battery pack or the electrical device. There is no problem as long as the function as the power supply system can be exerted altogether. It is preferable that information is transmitted between the battery pack and the electrical device by reading electronic information so that a charge is controlled.

The nonaqueous secondary battery, the battery pack, and the power supply system according to the embodiment of the invention are effective for an electrical device. The effect is particularly noticeable when used for an HEV (Hybrid Electric Vehicle) for which a charge up to the theoretical capacity is unnecessary and in which an assembled battery is formed using many cells.

More specifically, a nonaqueous secondary battery according to one aspect of the invention includes: a negative electrode containing at least one of a material capable of reversely inserting and extracting lithium and metal lithium as a negative electrode active material; a positive electrode containing lithium as a positive electrode active material; an electrolyte; and a heat resistant member provided between the negative electrode and the positive electrode and permeable to lithium ions while having heat resistance. In a case where a set voltage preset to a voltage lower than a voltage at which the electrolyte starts to decompose is applied between the negative electrode and the positive electrode, deposited metal is bridged between the negative electrode and the positive electrode according to the set voltage.

With the nonaqueous secondary battery configured as above, when the preset set voltage is applied between the negative electrode and the positive electrode, deposited metal is formed to bridge between the negative electrode and the positive electrode and the negative electrode and the positive electrode are short-circuited. A voltage between the negative electrode and the positive electrode is therefore maintained so as not to exceed the set voltage. Accordingly, the nonaqueous secondary battery as above is charged and the terminal voltage starts to rise and when the voltage between the negative electrode and the positive electrode reaches the set voltage, the terminal voltage is maintained so as not to exceed the set voltage even when the charge is continued. It is therefore possible to lower the risk of becoming an overcharge state. Also, in a case where an assembled battery in which a plurality of nonaqueous secondary batteries as above are connected in series, by applying a voltage equal to or higher than the set voltage to the respective nonaqueous secondary batteries, the voltages between the negative electrodes and the positive electrodes in all the nonaqueous secondary batteries substantially coincide with one another at the set voltage. It is therefore easy to reduce an imbalance among the respective nonaqueous secondary batteries.

Also, it is preferable that the set voltage is set to a voltage equal to a cut-off voltage of charge for a constant voltage charge by which a charge is performed by applying a constant voltage. When the set voltage is set to a voltage equal to the cut-off voltage of charge for a constant voltage charge, the voltages between the negative electrodes and the positive electrodes in the respective nonaqueous secondary batteries substantially coincide with one another at the cut-off voltage of charge. It is therefore easy to reduce an imbalance among the respective nonaqueous secondary batteries.

Also, it is preferable that the heat resistant member is a porous protective membrane containing resin and an inorganic oxide filler. According to this configuration, the porous protective membrane has heat resistance. Hence, even when the set voltage is applied between the negative electrode and the positive electrode and the negative electrode and the positive electrode are short-circuited with deposited metal and heat is generated, the porous protective membrane neither melts nor undergoes deformation. It is therefore possible to lower the risk that the short-circuited portion spreads and the nonaqueous secondary battery becomes an extraordinary heated state.

Also, it is preferable that a porous separator having a lower melting point than the heat resistant member and permeable to lithium ions is further provided between the negative electrode and the positive electrode, and that the separator is partially removed so that the lithium ions are allowed to migrate by bypassing the separator.

According to this configuration, when the preset set voltage is applied between the negative electrode and the positive electrode, deposited metal is formed at a point at which the separator is removed partially and the negative electrode and the positive electrode are short-circuited. A short circuit caused by the deposited metal does not occur indefinitely everywhere between the negative electrode and the positive electrode. This lowers the risk that short-circuited point caused by the deposited metal increases indefinitely. In a case where the nonaqueous secondary battery becomes hotter than the melting point of the separator, for example, when it is heated from the outside, the separator melts and the fine pore structure is clogged. Accordingly, the so-called shut down effect by which migration of ions is suppressed can be obtained. It thus becomes possible to enhance the safety under an extraordinary hot environment.

Also, it is preferable that the heat resistant member is provided in close contact with at least one of the negative electrode and the positive electrode. By providing the heat resistant member in close contact with at least one of the negative electrode and the positive electrode, the electrode and the heat resistant member are in close contact with each other, which makes it difficult to let metal be deposited on all over the electrode surface. The deposited metal is therefore grown more readily in a direction perpendicular to the electrode surface at the time of overcharge.

Also, the heat resistant member may be a separator. According to this configuration, because the separator has heat resistance, the negative electrode and the positive electrode are short-circuited with the deposited metal when the set voltage is applied between the negative electrode and the positive electrode. Hence, should heat be generated, the risk that the short-circuited portion spreads due to melting or deformation of the separator and the nonaqueous secondary battery becomes an extraordinary heated state can be lowered.

Also, it is preferable that the heat resistant member is porous and at least one of a thickness, a porosity, and a tortuosity of the heat resistant member, a diameter of pores making the heat resistant member porous, and an interval between the negative electrode and the positive electrode is set in such a manner that when the set voltage is applied between the negative electrode and the positive electrode, the deposited metal formed according to the set voltage is bridged between the negative electrode and the positive electrode.

According to this configuration, when the set voltage is applied between the negative electrode and the positive electrode, a short circuit caused by the deposited metal is allowed to occur between the negative electrode and the positive electrode.

Also, it is preferable that a point at which at least one of the thickness, the porosity, and the tortuosity of the heat resistant member and the diameter of pores making the heat resistant member porous is set is a part of the heat resistant member, and that in portions of the heat resistant member other than the part, at least one of the thickness, the porosity, and the tortuosity of the heat resistant member and the diameter of pores making the heat resistant member porous is set in such a manner that a voltage with which the deposited metal is bridged between the negative electrode and the positive electrode becomes higher than the set voltage.

According to this configuration, in a case where the set voltage is applied between the negative electrode and the positive electrode, the deposited metal is formed to bridge between the negative electrode and the positive electrode in a part of the heat resistant member to cause a short circuit whereas no short circuit caused by the deposited metal occurs in the other portions. Hence, a short circuit caused by the deposited metal does not occur indefinitely everywhere between the negative electrode and the positive electrode. The risk that the short-circuited point caused by the deposited metal increases indefinitely can be therefore lowered.

Also, it is preferable that a point at which the interval between the negative electrode and the positive electrode is set in such a manner that the deposited metal formed according to the set voltage to bridge between the negative electrode and the positive electrode is a part of each of the negative electrode and the positive electrode.

According to this configuration, when the set voltage is applied between the negative electrode and the positive electrode, the deposited metal is formed to bridge between the negative electrode and the positive electrode to cause a short circuit in a part of each of the negative electrode and the positive electrode, and no short circuit caused by the deposited metal occurs in any other portion. Hence, a short circuit caused by the deposited metal does not occur indefinitely everywhere between the negative electrode and the positive electrode. The risk that the short-circuited point caused by the deposited metal increases indefinitely can be therefore lowered.

Also, it is preferable that the thickness of the heat resistant member set in such a manner that the deposited metal formed according to the set voltage to bridge between the negative electrode and the positive electrode is in a range of 2.0 to 30 μm. It is preferable that the porosity of the heat resistant member set in such a manner that the deposited metal formed according to the set voltage to bridge between the negative electrode and the positive electrode is in a range of 40 to 65%. It is preferable that the tortuosity of the heat resistant member set in such a manner that the deposited metal formed according to the set voltage to bridge between the negative electrode and the positive electrode is in a range of 1.0 to 1.5. It is preferable that the diameter of pores in the heat resistant member set in such a manner that the deposited metal formed according to the set voltage to bridge between the negative electrode and the positive electrode is in a range of 0.05 to 3.0 μm. It is preferable that the interval between the negative electrode and the positive electrode set in such a manner that the deposited metal formed according to the set voltage to bridge therebetween is in a range of 2.0 to 30 μm.

By setting at least one of the thickness, the porosity, and the tortuosity of the heat resistant member, the diameter of pores making the heat resistant member porous, and the interval between the negative electrode and the positive electrode to the values specified above, the deposited metal is formed to bridge between the negative electrode and the positive electrode when the set voltage is applied between the negative electrode and the positive electrode.

Also, it is preferable that let A be a theoretical capacity of the positive electrode and B be a theoretical capacity of the negative electrode, then a theoretical capacity ratio B/A is in a range of 0.8 to 1.0.

According to this configuration, in a case where the theoretical capacity ration B/A is equal to or smaller than 1, the nonaqueous secondary battery is a battery whose capacity is regulated by the positive electrode. It is therefore possible to accurately achieve the object not to overcharge the positive electrode active material that lacks thermal stability. It should be noted that the theoretical capacity ratio B/A smaller than 0.8 is not preferable because utilization (actual capacity/theoretical capacity) with respect to the theoretical capacity of the positive electrode is deteriorated.

Also, it is preferable that the set voltage is in a range of 3.8 to 4.4 V. When the set voltage exceeds 4.4 V per cell, the positive electrode active material is readily charged to a region where it lacks thermal stability. Meanwhile, when the set voltage is smaller than 3.8 V per cell, utilization (actual capacity/theoretical capacity) with respect to the theoretical capacity of the positive electrode is deteriorated. Neither is therefore preferable.

Also, a battery pack according to another aspect of the invention includes an assembled battery in which any one of the nonaqueous secondary batteries described above is provided in a plural form and the nonaqueous secondary batteries are connected in series. When configured in this manner, by applying a voltage to the assembled battery in such a manner that an applied voltage per nonaqueous secondary battery is equal to or higher than the set voltage, deposited metal is formed to bridge between the negative electrode and the positive electrode in each nonaqueous secondary battery and the negative electrode and the positive electrode are short-circuited. A voltage between the negative electrode and the positive electrode is therefore maintained so as not to exceed the set voltage. Accordingly, the voltages between the negative electrodes and the positive electrodes in all the nonaqueous secondary batteries substantially coincide with one another at the set voltage. It is therefore easy to reduce an imbalance among the respective nonaqueous secondary batteries.

Also, it is preferable to further include: a connection terminal that receives a voltage used to charge the assembled battery; a charging voltage supply portion that charges the assembled battery by supplying the voltage received at the connection terminal; a voltage detection portion that detects terminal voltages across the respective nonaqueous secondary batteries; an imbalance detection portion that determines an occurrence of an imbalance in a charge state among the nonaqueous secondary batteries in a case where the terminal voltages across the nonaqueous secondary batteries detected by the voltage detection portion satisfy a preset specific determination condition; and an imbalance correction control portion that supplies the assembled battery with a voltage equal to the set voltage multiplied by the number of the nonaqueous secondary batteries in a case where the occurrence of an imbalance is determined by the imbalance detection portion.

According to this configuration, when a voltage to charge the assembled battery is supplied to the connection terminal of the battery pack from the outside, the nonaqueous secondary batteries included in the assembled battery are charged by this voltage. When the terminal voltages across the respective nonaqueous secondary batteries satisfy the predetermined specific determination condition, the occurrence of an imbalance in a charge state among the nonaqueous secondary batteries is determined by the imbalance detection portion. Then, a voltage equal to the set voltage multiplied by the number of the nonaqueous secondary batteries is supplied to the assembled battery by the imbalance correction control portion, that is, a voltage is applied to the assembled battery in such a manner that the applied voltage per nonaqueous secondary battery becomes the set voltage. Accordingly, deposited metal is formed to bridge between the negative electrode and the positive electrode in each nonaqueous secondary battery and the negative electrode and the positive electrode are short-circuited. The voltage between the negative electrode and the positive electrode is therefore maintained so as not to exceed the set voltage. The voltages between the negative electrodes and the positive electrodes in all the nonaqueous secondary batteries thus substantially coincide with one another at the set voltage. It is therefore easy to reduce an imbalance among the nonaqueous secondary batteries.

A power supply system according to still another aspect of the invention includes: an assembled battery in which any one of the nonaqueous secondary batteries described above is provided in a plural form and the nonaqueous secondary batteries are connected in series; a charging voltage supply portion that charges the assembled battery by supplying a charging voltage; a voltage detection portion that detects terminal voltages across the respective nonaqueous secondary batteries; an imbalance detection portion that determines an occurrence of an imbalance in a charge state among the nonaqueous secondary batteries in a case where the terminal voltages across the nonaqueous secondary batteries detected by the voltage detection portion satisfy a preset specific determination condition; and an imbalance correction control portion that supplies the assembled battery with a voltage equal to the set voltage multiplied by the number of the nonaqueous secondary batteries using the charging voltage supply portion in a case where the occurrence of an imbalance is determined by the imbalance detection portion.

According to this configuration, a charging voltage is supplied to the assembly battery by the charging voltage supply portion and the nonaqueous secondary batteries included in the assembled battery are charged. When the terminal voltages across the respective nonaqueous secondary batteries satisfy the predetermined specific determination condition, the occurrence of an imbalance in a charge state among the nonaqueous secondary batteries is determined by the imbalance detection portion. Then, a voltage equal to the set voltage multiplied by the number of the nonaqueous secondary batteries is supplied to the assembled battery by the imbalance correction control portion, that is, a voltage is applied to the assembled battery in such a manner that the applied voltage per nonaqueous secondary battery becomes the set voltage. Accordingly, the deposited metal is formed to bridge between the negative electrode and the positive electrode in each nonaqueous secondary battery and the negative electrode and the positive electrode are short-circuited. The voltage between the negative electrode and the positive electrode is therefore maintained so as not to exceed the set voltage. The voltages between the negative electrodes and the positive electrodes in all the nonaqueous secondary batteries thus substantially coincide with one another at the set voltage. It is therefore easy to reduce an imbalance among the nonaqueous secondary batteries.

A power supply system according to still another embodiment of the invention further includes: any one of the nonaqueous secondary batteries described above; a charging voltage supply portion that charges the nonaqueous secondary battery by supplying a charging voltage; a voltage detection portion that detects a terminal voltage across the nonaqueous secondary battery; and a charge control portion that inhibits a charge of the nonaqueous secondary battery when the terminal voltage across the nonaqueous secondary battery detected by the voltage detection portion reaches or exceeds a charge forced stopping voltage set to a voltage higher than the set voltage.

According to this configuration, any one of the nonaqueous secondary batteries described above is charged by the charging voltage supply portion. Also when the terminal voltage across the nonaqueous secondary battery reaches or exceeds the charge forced stopping voltage set to a voltage higher than the set voltage, a charge of the nonaqueous secondary battery is inhibited. Hence, the safety in the event that the terminal voltage across the nonaqueous secondary battery reaches or exceeds the charge forced stopping voltage because of an error can be enhanced.

Also, it is preferable that the charge forced stopping voltage is set in such a manner that a difference from the set voltage falls within a range of 0.1 to 0.3 V per nonaqueous secondary battery.

According to this configuration, when the terminal voltage across the nonaqueous secondary battery exceeds the set voltage by 0.3 V or more, a charge of the nonaqueous secondary battery is inhibited by the charge control portion. The safety can be therefore enhanced. Meanwhile, even when the terminal voltage across the nonaqueous secondary battery becomes higher than the set voltage, in a case where a difference between the voltages is less than 0.1 V, a charge of the nonaqueous secondary battery will not be inhibited by the charge control portion. Hence, the risk of inhibiting a charge erroneously can be reduced.

Also, an electrical device according to still another aspect of the invention includes any one of the nonaqueous secondary batteries described above, and a load circuit driven by power supplied from the nonaqueous secondary battery. According to this configuration, it is possible to lower the risk that the nonaqueous secondary battery that supplies power to the load circuit in the electrical device becomes an overcharge state.

### EXAMPLE

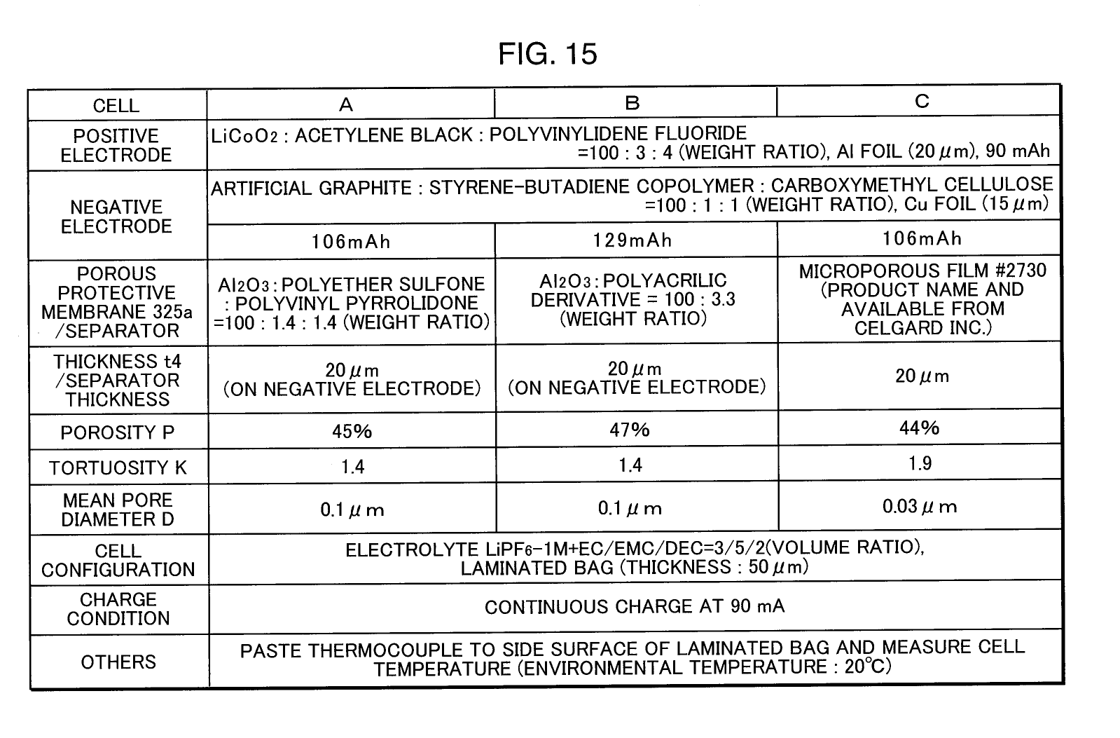

The inventors made cells A and B having the structure of the electrode plate group 312c shown in FIG. 7. Also, as a comparative example, the inventors prepared a cell C using a resin microporous film having no heat resistance as a separator. FIG. 15 is a view in a tabular form used to describe the configurations of the cells A, B, and C. As is set forth in FIG. 15, for the positive electrodes of the cells A and B, aluminum foil having a thickness of 20 μm was used as the positive electrode current collector 321 and LiCoO₂:acetylene black:polyvinylidene fluoride=100:3:4 (weight ratio) were used as the positive electrode active material 322. Herein, the theoretical capacity of the positive electrodes of the cells A and B was set to 90 mAh.

Also, for the negative electrodes of the cells A and B, copper foil having a thickness of 15 μm was used as the negative electrode current collector 323 and artificial graphite:styrene-butadiene copolymer:carboxymethyl cellulose=100:1:1 (weight ratio) were used as the negative electrode active material 324. Herein, the theoretical capacity of the negative electrode of the cell A was set to 106 mAh and the theoretical capacity of the negative electrode of the cell B was set to 129 mAh.

The porous protective membrane 325a of the cell A was made of Al₂O₃:polyether sulfone:polyvinyl pyrrolidone=100:1.4:1.4 (weight ratio). Also, the porous protective membrane 325a of the cell A was formed on the surface of the negative electrode plate 303 in the thickness t4 of 20 μm. In addition, the porous protective membrane 325a of the cell A was formed to have the porosity P of 45%, the tortuosity K of 1.4, and the mean pore diameter D of 0.1 μm. Herein, the tortuosity K was found by dividing “the average of the actual lengths of pores” by the mean value of the thickness t4.

The porous protective membrane 325a of the cell B was made of Al₂O₃:polyacrylic derivative=100:3.3 (weight ratio). Also, the porous protective membrane 325a of the cell B was formed on the surface of the negative electrode plate 303 in the thickness t4 of 20 μm. In addition, the porous protective membrane 325a of the cell B was formed to have the porosity P of 47%, the tortuosity K of 1.4, and the mean pore diameter D of 0.1 μm.

In the cell C of the comparative example, the positive electrode and the negative electrode were formed in the same manner as those in the cell A. The separator of the cell C was a microporous film #2730 (the product name and available from Celgard Inc.) and thickness was set to 20 μm. The separator of the cell C had the porosity of 44%, the tortuosity of 1.9, and the mean pore diameter of 0.03 μm.

The electrolyte of the cells A, B, and C was LiPF₆−1M+EC/EMC/DEC=3/5/2 (volume ratio). The cells A, B, and C were formed by sealing the foregoing members in a laminated bag having a thickness of 50 μm.

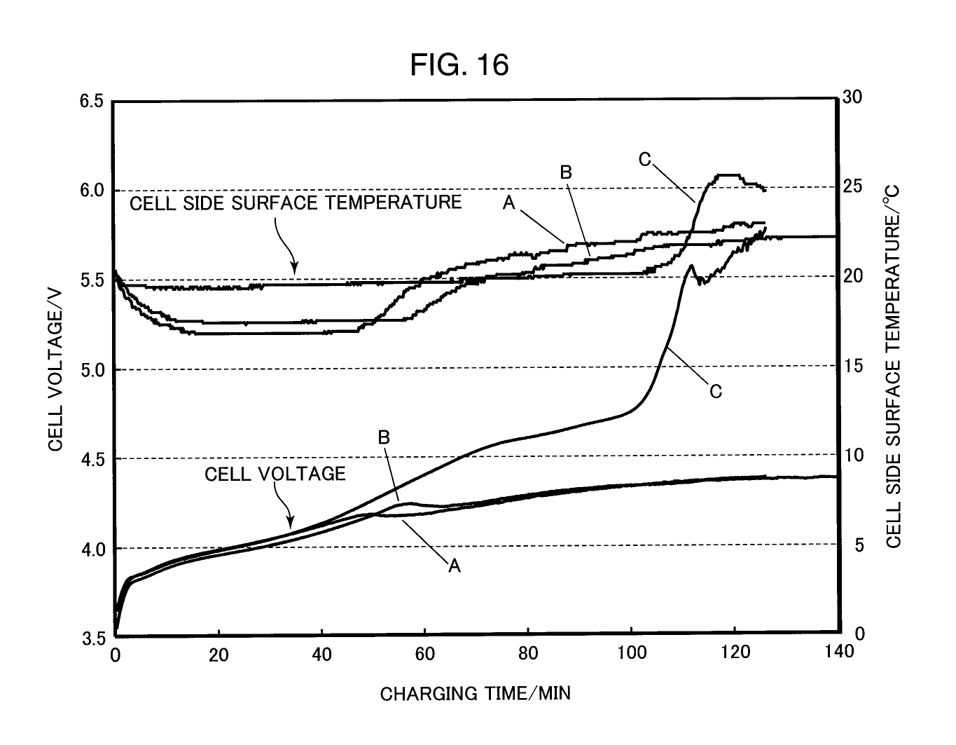

Regarding the behavior of the nonaqueous secondary battery used in the invention at the time of overcharge will be described in detail on the basis of the result of demonstration using test cells. FIG. 16 is a graph showing the experiment result obtained by measuring the cell voltages and the cell temperatures when the cells A, B, and C shown in FIG. 15 were charged. The charge was performed by a constant current charge at 90 mA. Also, the cell temperatures were measured using a thermocouple pasted to the side surface of the laminated bag of each cell in the environmental temperature of 20° C.

With the cell C using the microporous film as the separator, the cell voltage rose noticeably when the charging time was over about 40 minutes (corresponding to the SOC (State Of Charge) of 70%) and the cell voltage together with the side surface temperature rose abruptly when the charging time was over about 100 minutes (corresponding to the SOC of 170%). According to the cell configuration of this test, the suitable cut-off voltage of charge (equivalent to the upper limit voltage Vᵤ) was in the vicinity of 4.2 V. However, it is thought that the cell C failed to end the charge within this suitable range and fell into an extraordinary overcharge exceeding 4.8 V (involving a breaking of the crystalline structure of the positive electrode active material), which gave raise to noticeable heat generation.

Meanwhile, in the cells A and B using the porous protective membrane 325a (porous heat resistant layer) instead of the separator, the cell voltage dropped temporarily with a rise of the side surface temperature when the charging time was over about 50 minutes (corresponding to the SOC of 80%) and started to rise gradually thereafter. The phenomenon that the cell voltage drops temporarily with a rise of the side surface temperature is thought to be proof of the occurrence of an internal short circuit in the cell. Hence, after the charge was continued for 120 minutes, the cell A was disassembled to remove the positive electrode and the cross section and the surface thereof were examined carefully.

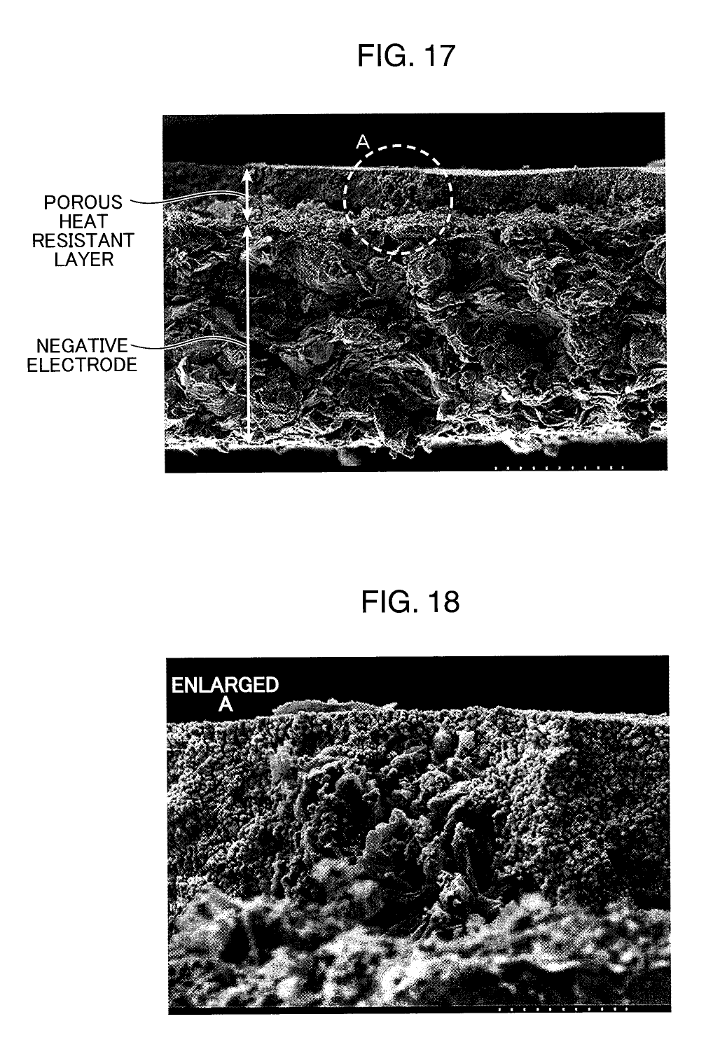

FIG. 17 through FIG. 19 are views showing electron microscopic (SEM) images of the cross sections of the negative electrode and the porous heat resistant layer in the cell A after the test shown in FIG. 16. Also, FIG. 20 through FIG. 22 are views showing electron microscopic (SEM) images of the surface of the porous heat resistant layer in the cell A after the test.

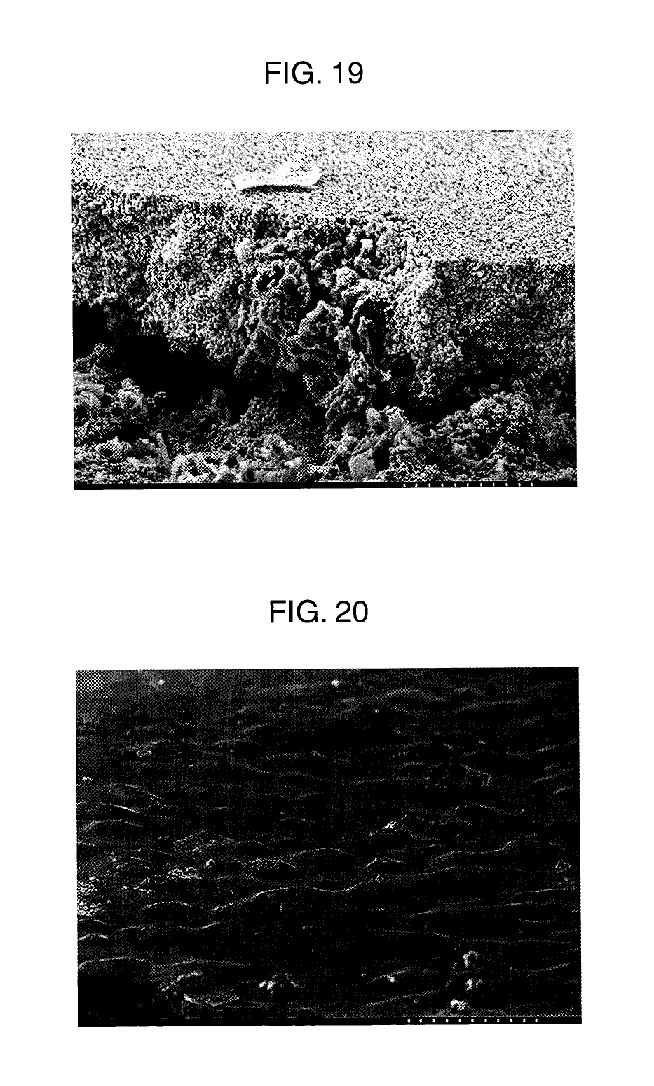

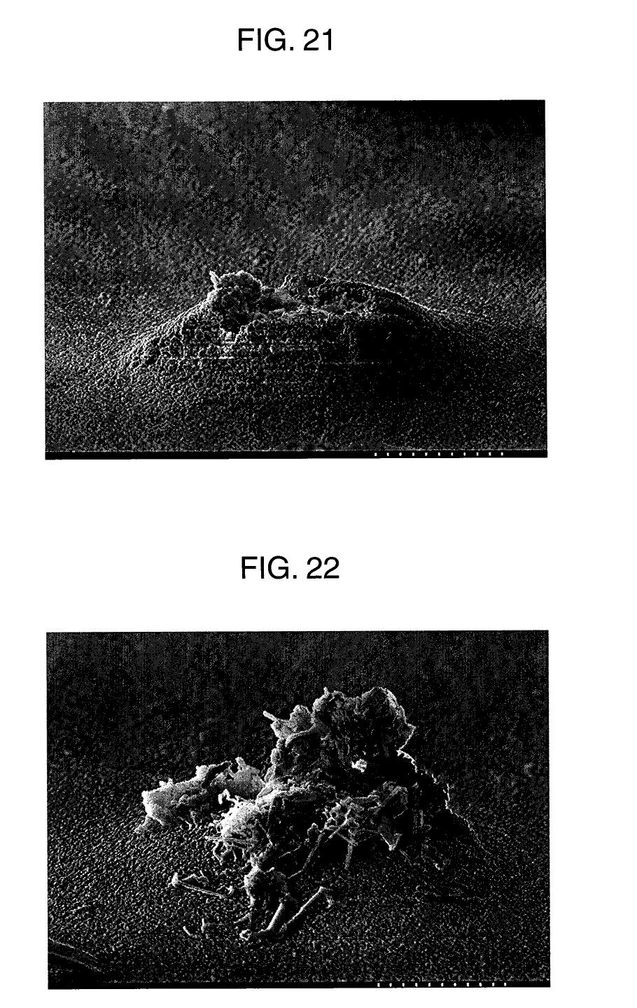

Referring to FIG. 17 through FIG. 22, the voltage used for the measurement with the electron microscopy was set to 5.0 kV. The magnification of FIG. 17 is 500 times and the scale at the lower right is 60.0 The magnification of FIG. 18 is 3000 times and the scale at the lower right is 10.0 The magnification of FIG. 19 is 2000 times and the scale at the lower right is 15.0 μm. The magnification of FIG. 20 is 200 times and the scale at the lower right is 150 μm. The magnification of FIG. 21 and FIG. 22 is 2000 times and the scale in the lower right is 15.0 μm.

FIG. 17 shows the entire cross sections of the negative electrode and the porous heat resistant layer. FIG. 18 and FIG. 19 show enlarged pictures of a portion encircled by a broken line A of FIG. 17. Also, FIG. 20 shows the entire surface of the porous heat resistant layer. FIG. 21 and FIG. 22 show enlarged pictures of FIG. 20.

From FIG. 17 through FIG. 22, it was confirmed that lithium dendrites were grown from the surface of the negative electrode through fine pores in the porous heat resistant layer and a part thereof passed the porous heat resistant layer. It is therefore inferred that a substantial overcharge (excessive rise of the cell voltage) is avoided in the course of repetition of a phenomenon in which lithium dendrites are grown consecutively while the cells are overcharged and a part thereof reaches the positive electrode to cause an internal short circuit, so that a further rise of the cell voltage is suppressed while heat is generated by a short circuit current flowing between the positive electrode and the negative electrode because of the internal short circuit to cause the short-circuited point itself to vanish.

As can be confirmed from FIG. 17 through FIG. 22, any of the points at which lithium dendrites passed the porous heat resistant layer is limited to a dot-like narrow area. Accordingly, it was confirmed that the short-circuited point will not spread even when a short circuit caused by lithium dendrites occurs.

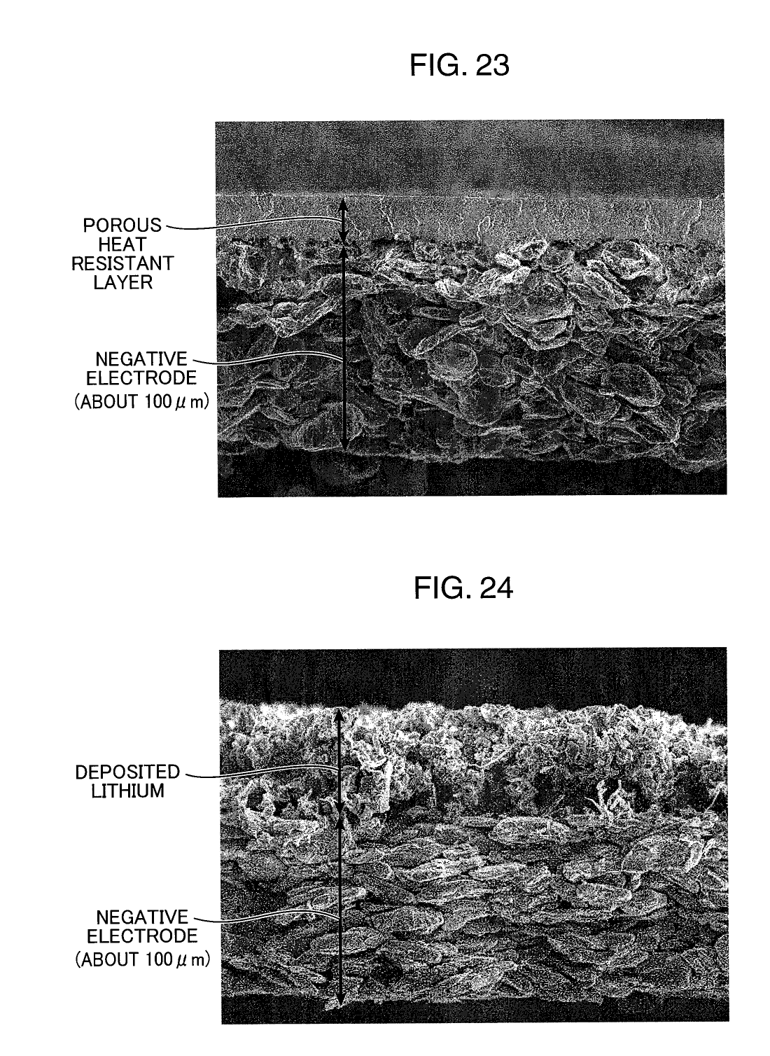

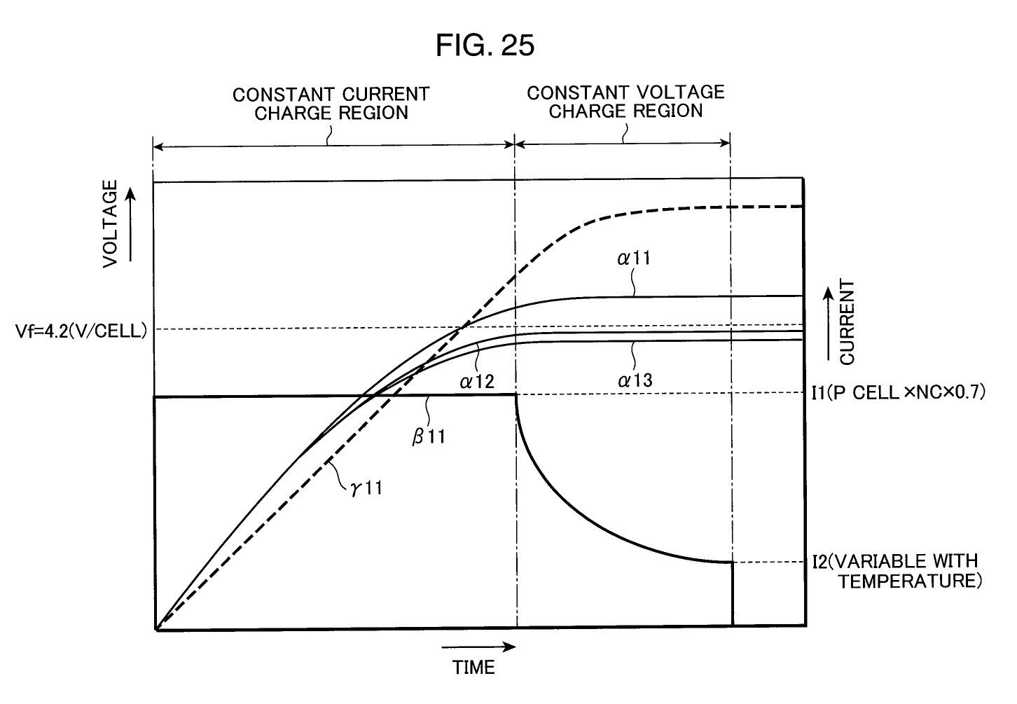

FIG. 23 is a view showing an electron microscopic (SEM) image of the cross section of the cell A after the overcharge test shown in FIG. 16. FIG. 24 is a view showing an electron microscopic (SEM) image of the cross section of the cell C of the comparative example after the overcharge test shown in FIG. 16. The picture of the cell C shown in FIG. 24 was taken in a state where the resin microporous film (separator) was removed.

From a comparison between the cell A shown in FIG. 23 and the cell C shown in FIG. 24, it can be confirmed that deposited lithium hardly deposited between the porous heat resistance layer and the negative electrode in the cell A whereas lithium deposited uniformly over a wide range on the negative electrode surface in the cell C shown in FIG. 24.

In this manner, in a case where the resin microporous film is used as the separator, it is thought that deposition of lithium spreads over a wide range when a short circuit caused by lithium dendrites occurs. Accordingly, it is thought that the temperature rises abruptly in the cell C as is shown in FIG. 16 because the positive electrode active material is ruined by an overcharge over a wide range in association with deposition of lithium.

As has been described, different from the cell C, lithium is not deposited over a wide range in the cells A and B. Hence, it is thought that an abrupt temperature rise associated with deposition of lithium as in the cell C does not occur in the cells A and B as is shown in FIG. 16.

The reason why deposited lithium (for example, lithium dendrites, mossy lithium, dendritic lithium, flat lithium, powdery lithium) does not select a growing spot remains unknown. However, this is thought to be attributed to the fact that the tortuosity of the fine pores in the porous heat resistant layer is markedly smaller than that in the microporous film.

For the cell A having the negative capacity smaller than that of the cell B, the heat generation timing caused by an internal short circuit comes earlier than in the cell B. From this point, it is inferred that the cut-off voltage of charge of the nonaqueous electrolyte secondary battery using the porous heat resistant layer instead of the separator is determined not by the materials forming the porous heat resistant layer but by a ratio of the negative electrode capacity with respect to the positive electrode capacity.

From the examination results of the disassembled cells A and B, it was confirmed that the artificial graphite on the electrode plate surface was in a charge state in gold whereas the artificial graphite in the vicinity of the copper foil remained in black and in a state at a low charging rate. The reason of this result is thought that the artificial graphite on the surface alone was charged because the electrode plate was thick. The reason why a short circuit caused by deposited lithium was confirmed at the SOC of 100% or below in the overcharge test described above is inferred that deposition of lithium on the surface started in a state at the SOC of 100% or below because of the thickness of the electrode plate.

Cells D through G, ten for each, were made in the same manner as with the cell A except that Al₂O₃ used in the respective cells had different particle diameters. The porous protective membrane in each cell was formed on the surface of the negative electrode plate in the thickness t4 of 20 μm. The porosities were 35% in the cell D, 40% in the cell E, 65% in the cell F, and 70% in the cell G.

A charge was performed by a constant current charge at 90 mA. The cell temperatures were measured using a thermocouple pasted to the side surface of the laminated bag of each cell at the environmental temperature of 20° C.

With the cell D having the porosity of 35%, the cell voltage rose noticeably when the charging time was over about 55 minutes and the cell voltage together with the side surface temperature rose abruptly when the charging time was over about 120 minutes.

By contrast, with the cell G having the porosity of 70%, a short circuit in the battery before a charge was confirmed in three cells among the ten cells. For the rest of the cells, a phenomenon that the cell voltage dropped temporarily with a rise of the side surface temperature in the charging time of within 30 minutes was confirmed. This indicates that the function of the insulating membrane was poor because the porosity of the insulating membrane was too high.

With the cell E having the porosity of 40% and the cell F having the porosity of 65%, a phenomenon in which the cell voltage dropped temporarily with a rise of the side surface temperature was confirmed in both after 50 minutes and no abrupt temperature rise in the cell was confirmed.

In view of the foregoing, it is understood that the porosity of the porous heat resistant layer is preferably 40 to 65%.

### INDUSTRIAL APPLICABILITY

The invention can be used suitably as a battery pack employed as the power supply in electrical devices, such as a portable personal computer, a digital camera, a mobile phone, a vehicle, such as an electric car and a hybrid car, and as a power supply system that charges the battery pack.

1. A nonaqueous secondary battery, comprising:
a negative electrode containing at least one of a material capable of reversely inserting and extracting lithium and metal lithium as a negative electrode active material;
a positive electrode containing lithium as a positive electrode active material;
an electrolyte; and
a heat resistant member provided between the negative electrode and the positive electrode and permeable to lithium ions while having heat resistance,
wherein in a case where a set voltage preset to a voltage lower than a voltage at which the electrolyte starts to decompose is applied between the negative electrode and the positive electrode, deposited metal is bridged between the negative electrode and the positive electrode according to the set voltage.

2. The nonaqueous secondary battery according to claim 1, wherein:
the set voltage is set to a voltage equal to a cut-off voltage of charge for a constant voltage charge by which a charge is performed by applying a constant voltage.

3. The nonaqueous secondary battery according to claim 1 or 2, wherein:
the heat resistant member is a porous protective membrane containing resin and an inorganic oxide filler.

4. The nonaqueous secondary battery according to claim 3, wherein:
a porous separator having a lower melting point than the heat resistant member and permeable to lithium ions is further provided between the negative electrode and the positive electrode; and
the separator is partially removed so that the lithium ions are allowed to migrate by bypassing the separator.

5. The nonaqueous secondary battery according to claim 1, wherein:
the heat resistant member is provided in close contact with at least one of the negative electrode and the positive electrode.

6. The nonaqueous secondary battery according to claim 1, wherein:
the heat resistant member is a separator.

7. The nonaqueous secondary battery according to claim 1, wherein:
the heat resistant member is porous and at least one of a thickness of the heat resistant member, a porosity of the heat resistant member, a tortuosity of the heat resistant member, a diameter of pores making the heat resistant member porous, and an interval between the negative electrode and the positive electrode is set in such a manner that when the set voltage is applied between the negative electrode and the positive electrode, the deposited metal is bridged between the negative electrode and the positive electrode according to the set voltage.

8. The nonaqueous secondary battery according to claim 7, wherein:
a point at which at least one of the thickness of the heat resistant member, the porosity of the heat resistant member, the tortuosity of the heat resistant member and the diameter of pores making the heat resistant member porous is set is a part of the heat resistant member; and
in portions of the heat resistant member other than the part, at least one of the thickness, the porosity, and the tortuosity of the heat resistant member and the diameter of pores making the heat resistant member porous is set in such a manner that a voltage with which the deposited metal is bridged between the negative electrode and the positive electrode becomes higher than the set voltage.

9. The nonaqueous secondary battery according to claim 7, wherein:
a point at which the interval between the negative electrode and the positive electrode is set in such a manner that the deposited metal is bridged between the negative electrode and the positive electrode according to the set voltage is a part of each of the negative electrode and the positive electrode.

10. The nonaqueous secondary battery according to claim 7, wherein:
the thickness of the heat resistant member set in such a manner that the deposited metal is bridged between the negative electrode and the positive electrode according to the set voltage is in a range of 2.0 to 30 μm.

11. The nonaqueous secondary battery according to claim 7, wherein:
the porosity of the heat resistant member set in such a manner that the deposited metal is bridged between the negative electrode and the positive electrode according to the set voltage is in a range of 40 to 65%.

12. The nonaqueous secondary battery according to claim 7, wherein:
the tortuosity of the heat resistant member set in such a manner that the deposited metal is bridged between the negative electrode and the positive electrode according to the set voltage is in a range of 1.0 to 1.5.

13. The nonaqueous secondary battery according to claim 7, wherein:
the diameter of pores in the heat resistant member set in such a manner that the deposited metal is bridged between the negative electrode and the positive electrode according to the set voltage is in a range of 0.05 to 3.0 μM.

14. The nonaqueous secondary battery according to claim 7, wherein:
the interval between the negative electrode and the positive electrode set in such a manner that the deposited metal is bridged therebetween according to the set voltage is in a range of 2.0 to 30 μm.

15. The nonaqueous secondary battery according to claim 1, wherein:
let A be a theoretical capacity of the positive electrode and B be a theoretical capacity of the negative electrode, then a theoretical capacity ratio B/A is in a range of 0.8 to 1.0.

16. The nonaqueous secondary battery according to claim 1, wherein:
the set voltage is in a range of 3.8 to 4.4 V.

17. A battery pack, comprising:
an assembled battery in which the nonaqueous secondary battery set forth in claim 1 is included in a plural form and the nonaqueous secondary batteries are connected in series.

18. The battery pack according to claim 17, further comprising:
a connection terminal that receives a voltage used to charge the assembled battery;
a charging voltage supply portion that charges the assembled battery by supplying the voltage received at the connection terminal;
a voltage detection portion that detects terminal voltages across the respective nonaqueous secondary batteries;
an imbalance detection portion that determines an occurrence of an imbalance in a charge state among the nonaqueous secondary batteries in a case where the terminal voltages across the nonaqueous secondary batteries detected by the voltage detection portion satisfy a preset specific determination condition; and
an imbalance correction control portion that supplies the assembled battery with a voltage equal to the set voltage multiplied by the number of the nonaqueous secondary batteries in a case where the occurrence of an imbalance is determined by the imbalance detection portion.

19. A power supply system, comprising:
an assembled battery in which the nonaqueous secondary battery set forth in claim 1 is provided in a plural form and the nonaqueous secondary batteries are connected in series;
a charging voltage supply portion that charges the assembled battery by supplying a charging voltage;
a voltage detection portion that detects terminal voltages across the respective nonaqueous secondary batteries;
an imbalance detection portion that determines an occurrence of an imbalance in a charge state among the nonaqueous secondary batteries in a case where the terminal voltages across the nonaqueous secondary batteries detected by the voltage detection portion satisfy a preset specific determination condition; and
an imbalance correction control portion that supplies the assembled battery with a voltage equal to the set voltage multiplied by the number of the nonaqueous secondary batteries using the charging voltage supply portion in a case where the occurrence of an imbalance is determined by the imbalance detection portion.

20. A power supply system, comprising:
the nonaqueous secondary battery set forth in claim 1;
a charging voltage supply portion that charges the nonaqueous secondary battery by supplying a charging voltage;
a voltage detection portion that detects a terminal voltage across the nonaqueous secondary battery; and
a charge control portion that inhibits a charge of the nonaqueous secondary battery when the terminal voltage across the nonaqueous secondary battery detected by the voltage detection portion reaches or exceeds a charge forced stopping voltage set to a voltage higher than the set voltage.

21. The power supply system according to claim 20, wherein:
the charge forced stopping voltage is set in such a manner that a difference from the set voltage falls within a range of 0.1 to 0.3 V per nonaqueous secondary battery.

22. An electrical device, comprising:
the nonaqueous secondary battery set forth in claim 1; and
a load circuit driven by power supplied from the nonaqueous secondary battery.
